(19) United States
(12) Patent Application Publication
(10) Pub. No.: US 2019/0051270 A1
(43) Pub. Date: Feb. 14, 2019

(54) DISPLAY PROCESSING DEVICE AND IMAGING DEVICE

(71) Applicant: OLYMPUS CORPORATION, Tokyo (JP)

(72) Inventors: Ryusuke Tsuchida, Tokyo (JP); Akira Ueno, Tokyo (JP)

(73) Assignee: OLYMPUS CORPORATION, Tokyo (JP)

(21) Appl. No.: 16/161,855

(22) Filed: Oct. 16, 2018

Related U.S. Application Data
(63) Continuation of application No. PCT/JP2016/063038, filed on Apr. 26, 2016.

(51) Int. Cl. G09G 5/397; G09G 5/02; G09G 5/00

(52) U.S. Cl. CPC G09G 5/397; G09G 5/026; G09G 2340/02; G09G 2340/125; G09G 2350/00; G09G 5/003

(57) ABSTRACT

The present invention provides a display processing device for superimposing a superimposed image for displaying additional information on a display image on the basis of transparency information when each pixel is displayed and causing the superimposed image superimposed on the display image to be displayed. The display processing device comprising a superimposed image generation section configured to generate the superimposed image including the transparency information, generate a transparency map indicating transparency and non-transparency in each pixel included in the superimposed image on the basis of the transparency information, and cause the superimposed image and the transparency map to be stored being associated with each other, and a display processing section configured to superimpose a pseudo-pixel representing that a pixel is a transparent pixel in a pseudo manner when the transparent pixel included in the superimposed image which has not been acquired is superimposed on the display image on the basis of the transparency map which has been pre-acquired.

This application is a continuation application based on PCT Patent Application No. PCT/JP 2016/063038, filed Apr. 26, 2016 and amended Jul. 10, 2017 under Article 19.

### TECHNICAL FIELD

The present invention relates to a display processing device and an imaging device.

### BACKGROUND ART

Imaging devices such as a still-image camera and a moving-image camera have a function of displaying a captured image on a display device. As the display device on which the captured image is displayed by the imaging device, for example, there is a display device mounted on an imaging device such as a thin film transistor (TFT) liquid crystal display (LCD) or an electronic viewfinder (EVF). Also, as another display device, for example, there is also an external display device (an external display) connected to the imaging device such as a television (TV), a TFT monitor, or an organic electroluminescence (EL) display. In this manner, display devices for displaying images captured by the imaging device include various types of display devices having different frame rates or resolutions.

Thus, a display processing device provided in the imaging device for generating an image for causing the display device to display the captured image (a display image) is required to have a function of generating display images corresponding to various types of display devices. Also, because a function of causing a plurality of display devices to display captured images at the same time has also been required by recent imaging devices, the display processing device is also required to have a function of generating a plurality of display images at the same time.

Also, in recent years, with the enhancement of definition of a display device, for example, a full HD (1920×1080) size television (HDTV: high-definition television) obtained by increasing the definition of a conventional VGA (640×480) size TV in TVs has become mainstream. Also, ultra-high definition televisions (UHDTVs) with a 4K2K (3840×2160) size which have a higher definition have recently been put to practical use. Thus, higher performance is required for a display processing device provided in an imaging device.

Meanwhile, in a general imaging device, an image processing device such as a system LSI having a configuration in which a plurality of processing devices for implementing various functions in an imaging device, such as the above-described display processing devices, are connected to a common data bus is mounted and a storage device such as, for example, a dynamic random access memory (DRAM), for temporarily storing captured image data and the like is configured to be connected to the data bus configured in the image processing device. Thus, when a display process of generating a display image is performed, the display processing device acquires captured image data to be subjected to the display process from the DRAM according to direct memory access (DMA) transfer via the data bus. At this time, the amount of captured image data acquired by the display processing device from the DRAM via the data bus according to the DMA transfer increases with an increase in definition of the display device for displaying the display image. An increase in the amount of data of the captured image acquired from the DRAM according to the DMA transfer is a cause of an overload on the bus bandwidth of the DMA transfer in the data bus configured in the image processing device.

Also, in an imaging device, for example, an image for showing various information such as information about the imaging device such as the remaining amount of power of a battery provided in the imaging device and information about a captured image such as a photographing date and time is superimposed as an on-screen display (OSD) image on a display image and the image superimposed on the display image is displayed on a display device. A process of superimposing the OSD image on the display image is also performed by the display processing device. Thus, the display processing device acquires data of the superimposed OSD image from the DRAM according to the DMA transfer via the data bus together with data of the captured image serving as a target of a display process.

In general, for the OSD image data, data for one side of the display image is stored in the DRAM in a type in which color information indicating a color when information is displayed and transparency information indicating transparency (translucency according to some cases) are combined for each pixel in the display image. Thus, when the size of the display image (the number of pixels) generated according to high definition of the display device for displaying the display image increases, the amount of OSD image data also increases and further overload on the bus bandwidth of the DMA transfer in the data bus configured in the image processing device is caused. This is because the display processing device also needs to acquire OSD image data for one side of the display image from the DRAM in a region where a pixel included in the display image generated on the basis of the captured image is displayed on the display device, i.e., a region in which only transparency information indicating that a pixel is transparent is configured, instead of color information for displaying information.

Recently, the number of colors and gradations when information is displayed on a display device, i.e., the number of colors and gradations of an OSD image, have also increased according to the enhancement of definition of a display device. Thus, the amount of data per pixel in the OSD image has increased and an overload on the bus bandwidth of the DMA transfer in the data bus has increased further.

Therefore, for example, as disclosed in Japanese Unexamined Patent Application, First Publication No. 2008-181017, a technology of a display processing device for reducing an amount of OSD image data has been disclosed. In the technology disclosed in Japanese Unexamined Patent Application, First Publication No. 2008-181017, an overload on the bus bandwidth when the DMA transfer is performed is reduced by performing run-length compression on OSD image data for each line in a scanning direction and reducing an amount of data when the display processing device acquires OSD image data from the DRAM. By utilizing the concept of the technology disclosed in Japanese Unexamined Patent Application, First Publication No. 2008-181017, it is possible to minimize an overload on the bus bandwidth when the DMA transfer is performed even when the definition of a display device is enhanced.

### SUMMARY OF INVENTION

### Solution to Problem

According to a first aspect of the present invention, there is provided a display processing device for superimposing a superimposed image for displaying additional information on a display image on the basis of transparency information indicating transparency when each pixel included in the superimposed image is displayed and causing the superimposed image superimposed on the display image to be displayed, the display processing device comprising a superimposed image generation section, and a display processing section, wherein the superimposed image generation section is configured to generate the superimposed image including the transparency information, generate a transparency map indicating whether each pixel included in the superimposed image is a transparent pixel or a non-transparent pixel on the basis of the transparency information, and cause a storage section connected to a common bus to store the superimposed image and the transparency map, the superimposed image and the transparency map being associated with each other, the display processing section is configured to superimpose a pseudo-pixel representing that a pixel is a transparent pixel in a pseudo manner when the transparent pixel included in the superimposed image which has not been acquired from the storage section in predetermined units of transfers is superimposed on the display image on the basis of the transparency map which has been pre-acquired from the storage section, wherein the superimposed image generation section is configured to generate the transparency map having a smaller amount of data than the superimposed image, wherein the display processing section includes a superimposed image acquisition determination section, a superimposed image acquisition section, and an image superimposition section, the superimposed image acquisition determination section is configured to determine whether or not to acquire the transparent pixel included in the acquired superimposed image in the units of transfers on the basis of the transparency map corresponding to the acquired superimposed image before the superimposed image is acquired from the storage section, and to output a flag signal indicating a determination result; the superimposed image acquisition section is configured not to acquire the transparent pixel indicated not to be acquired by the flag signal in the units of transfers when the superimposed image is acquired from the storage section in the units of transfers, and to output an image for superimposition including the pseudo-pixel instead of the transparent pixel which has not acquired; and the image superimposition section is configured to superimpose the image for superimposition on the display image and generate an image signal for causing the image for superimposition superimposed on the display image to be displayed on the display device, wherein the superimposed image generation section is configured to calculate a transparency ratio which is a ratio of transparent pixels to pixels included in the superimposed image, wherein the superimposed image acquisition determination section is configured to acquire the transparency map from the storage section if the transparency ratio is greater than or equal to a predetermined threshold value and outputs the flag signal indicating the determination result on the basis of the acquired transparency map, and wherein the superimposed image acquisition determination section is configured not to acquire the transparency map from the storage section if the transparency ratio is less than the threshold value, and to output the flag signal indicating that all pixels included in the acquired superimposed image are acquired in the units of transfers.

According to a second aspect of the present invention, in the display processing device of the above-described first aspect, the superimposed image generation section may be configured to generate the superimposed image and the transparency map during a period in which the superimposed image acquisition section does not acquire the superimposed image.

According to a third aspect of the present invention, in the display processing device of the above-described second aspect, the display processing section may further include a synchronous signal generation section configured to generate a synchronous signal, the synchronous signal being the timing signal for causing the display device to display the image signal, and a period in which the superimposed image acquisition section does not acquire the superimposed image may be a blanking period indicated by the synchronous signal.

According to a fourth aspect of the present invention, in the display processing device of the above-described third aspect, the superimposed image generation section may start the generation of the superimposed image and the transparency map from a timing of a start of the blanking period.

According to a fifth aspect of the present invention, in the display processing device of the above-described third aspect, the superimposed image generation section may start the generation of the superimposed image and the transparency map from a timing at which a predetermined period has elapsed from a start of the blanking period.

According to a sixth aspect of the present invention, in the display processing device of the above-described first aspect, the superimposed image generation section may be configured to generate the superimposed image and the transparency map during a division period in which the amount of data transfers in the common bus measured for each division period obtained by dividing a period in which a bus bandwidth monitor connected to the common bus causes the display device to display the image signal into predetermined equal intervals is small.

According to a seventh aspect of the present invention, there is provided an imaging device including a display processing device for superimposing a superimposed image for displaying additional information on a display image on the basis of transparency information indicating transparency when each pixel included in the superimposed image is displayed and causing the superimposed image superimposed on the display image to be displayed, the display processing device comprising a superimposed image generation section, and a display processing section, wherein the superimposed image generation section is configured to generate the superimposed image including the transparency information, generate a transparency map indicating whether each pixel included in the superimposed image is a transparent pixel or a non-transparent pixel on the basis of the transparency information, and cause a storage section connected to a common bus to store the superimposed image and the transparency map, the superimposed image and the transparency map being associated with each other, the display processing section is configured to superimpose a pseudo-pixel representing that a pixel is a transparent pixel in a pseudo manner when the transparent pixel included in the superimposed image which has not been acquired from the storage section in predetermined units of transfers is superimposed on the display image on the basis of the transparency map which has been pre-acquired from the storage section, wherein the superimposed image generation section is configured to generate the transparency map having a smaller amount of data than the superimposed image, wherein the display processing section includes a superimposed image acquisition determination section, a superimposed image acquisition section, and an image superimposition section, the superimposed image acquisition determination section is configured to determine whether or not to acquire the transparent pixel included in the acquired superimposed image in the units of transfers on the basis of the transparency map corresponding to the acquired superimposed image before the superimposed image is acquired from the storage section, and to output a flag signal indicating a determination result, the superimposed image acquisition section is configured not to acquire the transparent pixel indicated not to be acquired by the flag signal in the units of transfers when the superimposed image is acquired from the storage section in the units of transfers, and to output an image for superimposition including the pseudo-pixel instead of the transparent pixel which has not acquired; and the image superimposition section is configured to superimpose the image for superimposition on the display image and generate an image signal for causing the image for superimposition superimposed on the display image to be displayed on the display device, wherein the superimposed image generation section is configured to calculate a transparency ratio which is a ratio of transparent pixels to pixels included in the superimposed image, wherein the superimposed image acquisition determination section is configured to acquire the transparency map from the storage section if the transparency ratio is greater than or equal to a predetermined threshold value and outputs the flag signal indicating the determination result on the basis of the acquired transparency map, and wherein the superimposed image acquisition determination section is configured not to acquire the transparency map from the storage section if the transparency ratio is less than the threshold value, and to output the flag signal indicating that all pixels included in the acquired superimposed image are acquired in the units of transfers.

### BRIEF DESCRIPTION OF DRAWINGS

FIG. 1 is a block diagram showing a schematic configuration of an imaging device equipped with an image processing device including a display processing device according to an embodiment of the present invention.

FIG. 2 is a diagram schematically showing a process when a display processing section constituting the display processing device according to the embodiment of the present invention causes an image to be displayed.

FIG. 3 is a block diagram showing a schematic configuration of the display processing section constituting the display processing device according to the embodiment of the present invention.

FIG. 4 is a diagram schematically showing an example of OSD image data generated by an OSD data generation section constituting the display processing device according to the embodiment of the present invention.

FIG. 5 is a diagram schematically showing an example of a process of converting OSD image data in a data superimposition section provided in the display processing section constituting the display processing device according to the embodiment of the present invention.

FIG. 6 is a diagram schematically showing an example of an OSD transparency map generated by the OSD data generation section constituting the display processing device according to the embodiment of the present invention.

FIG. 7 is a timing chart showing an example of timings at which the OSD data generation section constituting the display processing device according to the embodiment of the present invention is configured to generate OSD image data and an OSD transparency map.

FIG. 8 is a timing chart showing another example of timings at which the OSD data generation section constituting the display processing device according to the embodiment of the present invention is configured to generate OSD image data and an OSD transparency map.

FIG. 9 is a diagram showing an operation of the display processing section included in the display processing device according to the embodiment of the present invention.

FIG. 10 is a diagram schematically showing a state of a DMA transfer of the display processing section included in the display processing device according to the embodiment of the present invention.

FIG. 11 is a flowchart showing a schematic operation for switching a method of acquiring OSD image data for displaying an OSD image in the display processing device according to the embodiment of the present invention.

### DESCRIPTION OF EMBODIMENTS

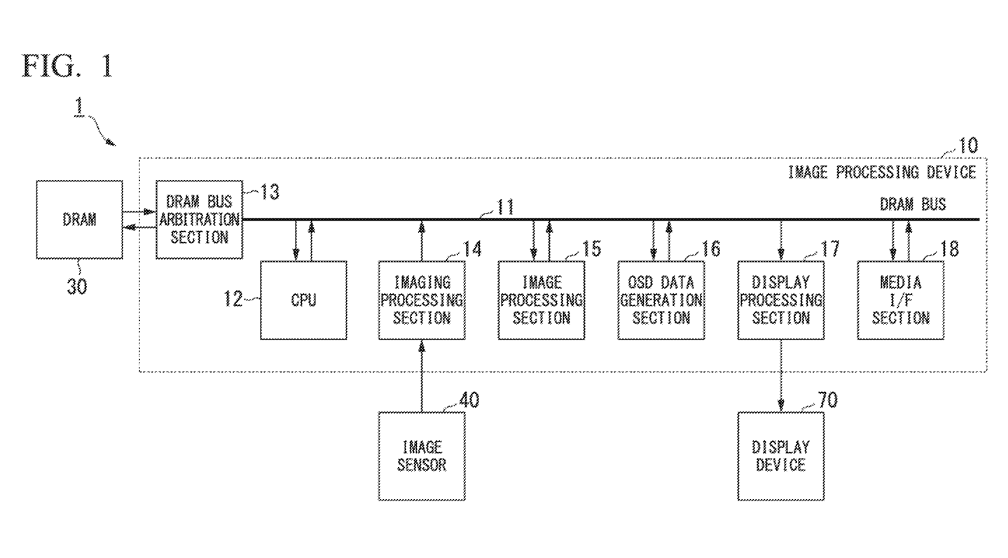

Hereinafter, embodiments of the present invention will be described with reference to the drawings. In the following description, for example, a case in which a display processing device according to the embodiment of the present invention is provided in an image processing device mounted on an imaging device such as a still-image camera will be described. FIG. 1 is a block diagram showing a schematic configuration of the imaging device equipped with the image processing device including the display processing device according to the embodiment of the present invention.

An imaging device 1 shown in FIG. 1 includes an image processing device 10, a dynamic random access memory (DRAM) 30, an image sensor 40, and a display device 70. Also, the image processing device 10 includes a central processing unit (CPU) 12, a DRAM bus arbitration section 13, an imaging processing section 14, an image processing section 15, an on-screen display (OSD) data generation section 16, a display processing section 17, and a media interface (I/F) section 18. In the image processing device 10, each of the CPU 12, the DRAM bus arbitration section 13, the imaging processing section 14, the image processing section 15, the OSD data generation section 16, the display processing section 17, and the media interface section 18 is connected to a DRAM bus 11 which is a common data bus. Also, in the imaging device 1 shown in FIG. 1, a configuration of the OSD data generation section 16 and the display processing section 17 corresponds to the display processing device of the present invention.

The imaging device 1 captures an image of a subject with the image sensor 40 and causes the display device 70 to display an image (a display image) according to the captured image. At this time, in the imaging device 1, for example, an OSD image for displaying various information such as information about the imaging device, for example, such as the remaining amount of power of a battery, and information about a captured image, for example, such as a photographing date and time, as additional information is superimposed on the display image and the OSD image superimposed on the display image is displayed on the display device 70.

The image sensor 40 is a solid-state imaging device represented by a charge coupled device (CCD) image sensor or a complementary metal oxide semiconductor (CMOS) image sensor configured to photoelectrically convert an optical image of a subject formed by a lens (not shown) provided in the imaging device 1. The image sensor 40 outputs a pixel signal corresponding to the optical image of the imaged subject to the imaging processing section 14 in accordance with control from the imaging processing section 14 provided in the image processing device 10.

The DRAM 30 is a data storage section configured to store various data processed in the imaging device 1. The DRAM 30 is connected to the DRAM bus 11 via the DRAM bus arbitration section 13 provided in the image processing device 10. The DRAM 30 stores image data of each processing step in the imaging device 1. For example, the DRAM 30 stores pixel data output by the imaging processing section 14 on the basis of the pixel signal output from the image sensor 40. Also, for example, the DRAM 30 stores data of an image (a captured image or a display image) generated by the image processing section 15 provided in the image processing device 10 and data of an OSD image generated by the OSD data generation section 16.

The display device 70 is a display device configured to display the display image and the OSD image output from the display processing section 17 provided in the image processing device 10. The display device 70 includes various display devices which display different sizes of display images and OSD images, i.e., which have a different number of pixels. For example, the display device 70 includes a small-size display device mounted on the imaging device 1 such as a thin film transistor (TFT) liquid crystal display (LCD) or an organic electroluminescence (EL) display for displaying an image of a VGA (640×480) size and configured to operate as a viewfinder for checking a subject to be photographed. Also, for example, the display device 70 includes a large-size display device which has a configuration capable of being attached to and detached from the imaging device 1 such as a high-definition television (HDTV) for displaying images with a full HD (1920×1080) size and which enables a captured image to be checked.

The image processing device 10 performs predetermined image processing on pixel signals output from the image sensor 40 to generate captured images and display images. Then, the image processing device 10 causes the display device 70 to display the generated display images. Also, the image processing device 10 causes a recording medium (not shown) to record the generated captured images.

The CPU 12 is a control section connected to the DRAM bus 11 and configured to control each component provided in the image processing device 10. The CPU 12 controls the entire image processing device 10 in accordance with programs and data for controlling each component. Also, the CPU 12 may control the components provided in the imaging device 1. Programs and data for the CPU 12 to control the components may be stored in the DRAM 30 connected to the DRAM bus 11 via the DRAM bus arbitration section 13.

The DRAM bus arbitration section 13 arbitrates an access request based on direct memory access (DMA) (a DMA request) from each component within the image processing device 10 connected to the DRAM bus 11 to the DRAM 30. Also, as a result of arbitrating the DMA request from each component to the DRAM 30, the DRAM bus arbitration section 13 transmits and receives data via the DRAM bus 11 between the component receiving the DMA request and the DRAM 30, i.e., controls the DMA transfer. More specifically, the DRAM bus arbitration section 13 transfers (writes) the data output by the component receiving the DMA request to the DRAM bus 11 to the DRAM 30, and controls the output to the component receiving the DMA request of the data acquired (read) from the DRAM 30.

The imaging processing section 14 performs predetermined imaging processing on the pixel signal output from the image sensor 40, thereby generating image data based on the pixel signal. The imaging processing performed by the imaging processing section 14 on the pixel signal output from the image sensor 40 is so-called pre-processing such as defect correction and shading correction. The imaging processing section 14 causes the DRAM 30 to record (write) data of the image generated by the preprocessing (hereinafter referred to as the “pre-processed image”) according to the DMA transfer.

The image processing section 15 acquires (reads) data of the pre-processed image recorded in the DRAM 30 according to the DMA transfer and performs predetermined image processing on the acquired pre-processed image data, thereby generating an image based on the pre-processed image. The image processing to be performed on the pre-processed image data by the image processing section 15 includes various types of image processing for display or image processing for recording such as a noise removal process, a YC conversion process, a resizing process, and moving-image compression processes such as a JPEG compression process, an MPEG compression process, and an H.264 compression process. The image processing device 10 causes the DRAM 30 to record (write) data of the display image generated by performing the image processing for display on the data of the pre-processed image (hereinafter referred to as “display image data”) according to the DMA transfer. Also, the image processing device 10 causes the DRAM 30 to record (write) data of the captured image generated by performing the image processing for recording on the data of the pre-processed image according to the DMA transfer.

The OSD data generation section 16 is configured to generate an OSD image showing various information to be superimposed on the display image as additional information (hereinafter referred to as “OSD information”) in accordance with an operation mode and settings of the imaging device 1. The OSD image is data of a type of image in which color information indicating a color when the OSD information is displayed at a position of each pixel included in the display image and transparency information indicating transparency or non-transparency (translucency according to some cases) are combined, i.e., so-called bitmap data. The OSD data generation section 16 causes the DRAM 30 to record (write) data of the generated OSD image (hereinafter referred to as “OSD image data”) according to the DMA transfer.

Also, the OSD data generation section 16 is configured to generate an OSD transparency map indicating whether or not each pixel included in the OSD image is transparent when the OSD image is generated or on the basis of the transparency information included in the generated OSD image. The OSD transparency map is bitmap data indicating whether or not each pixel included in the OSD image is transparent by 1-bit data. For example, the OSD transparency map is bitmap data indicating a pixel value (data) by “0” when the pixel included in the OSD image is transparent and indicating a pixel value by “1” when the pixel included in the OSD image is non-transparent or translucent. That is, the OSD transparency map is bitmap data having a smaller amount of data than the OSD image data.

Also, the OSD transparency map is not limited to a type of bitmap data indicating whether or not each pixel included in the OSD image is transparent by 1-bit data and may be bitmap data which also indicates that each pixel included in the OSD image is translucent. For example, a bit width of the OSD transparency map may be indicated by 2 bits, a pixel value (data) when the pixel included in the OSD image is transparent may be indicated by “0”, a pixel value when the pixel included in the OSD image is translucent may be indicated by “1”, and a pixel value (data) when the pixel included in the OSD image is non-transparent may be indicated by “2”.

When the generated OSD image data is recorded (written) in the DRAM 30 according to the DMA transfer, the OSD data generation section 16 causes the DRAM 30 to record (write) data of the generated OSD transparency map in association with the OSD image data. Also, detailed description of the configuration of the OSD transparency map generated by the OSD data generation section 16 will be described below.

Also, information of the operation mode and settings of the imaging device 1 for generating the OSD image in the OSD data generation section 16 is, for example, information generated on the basis of information of an operation performed by a user of the imaging device 1 on a user interface section (not shown) provided in the imaging device 1, information generated on the basis of information of an operation performed by the user acquired by, for example, the CPU 12, from the user interface section (not shown), or the like. However, in the present invention, information for generating the OSD image in the OSD data generation section 16 is not particularly limited.

The display processing section 17 acquires (reads) the display image data recorded in the DRAM 30 according to the DMA transfer and causes the display device 70 to display a display image according to the acquired display image data. Also, the display processing section 17 also acquires (reads) the OSD image data recorded in the DRAM 30 according to the DMA transfer and causes the display device 70 to display an image to be superimposed and displayed on an image according to the acquired OSD image data, i.e., the display image according to the display image data. At this time, before the OSD image data is acquired from the DRAM 30 according to the DMA transfer, the display processing section 17 acquires (reads) data of the OSD transparency map recorded in the DRAM 30 according to the DMA transfer, and determines (decides) whether or not to acquire (read) the OSD image data from the DRAM 30 on the basis of the data of the acquired OSD transparency map. Then, the display processing section 17 acquires (reads) the OSD image data determined to be acquired (read) from the DRAM 30 according to the DMA transfer, superimposes an OSD image according to the acquired OSD image data on an image to be displayed on the display device 70, and causes the OSD image superimposed on the image to be displayed. Detailed description of the configuration of the display processing section 17 and the DMA transfer method in which the display processing section 17 acquires (reads) data of the OSD image and the OSD transparency map from the DRAM 30 will be given below.

The media interface section 18 acquires (reads) the data of the captured image recorded in the DRAM 30 according to the DMA transfer, and causes the recording medium (not shown) to record the acquired captured image data. The recording medium in which the captured image data is recorded by the media interface section 18 includes recording media of various configurations, for example, such as an SD memory card and compact flash (CF (registered trademark)).

According to such a configuration, the imaging device 1 superimposes an OSD image for displaying various OSD information on an image (a display image) according to the image of the subject captured by the image sensor 40 (a captured image) and displays the OSD image on the display device 70. Also, the imaging device 1 can cause the recording medium to record the image according to the image of the subject captured by the image sensor 40 (the captured image).

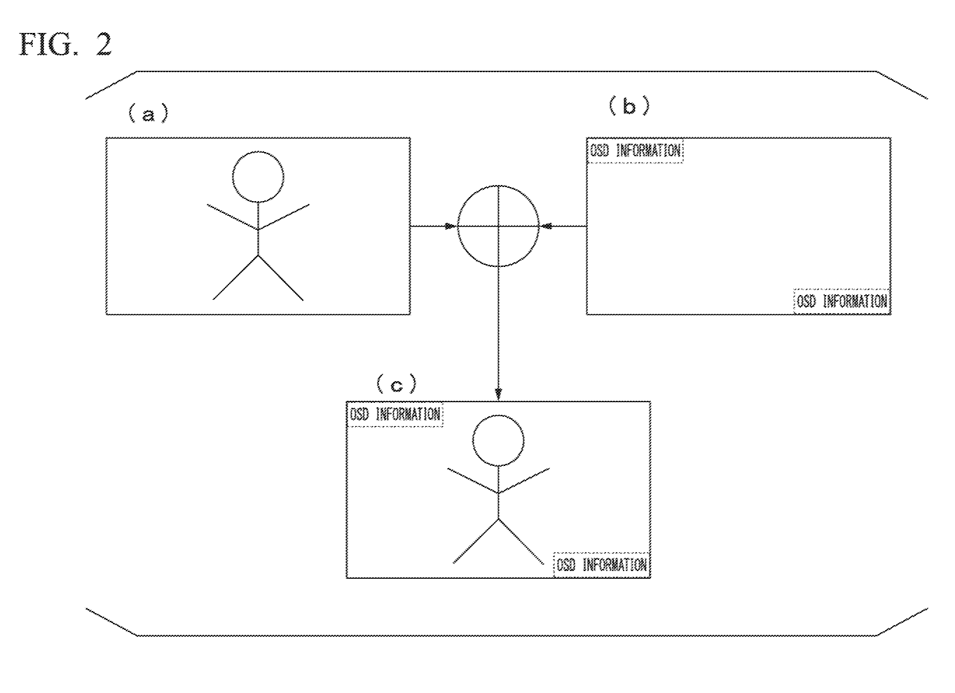

Next, the configuration and operation of the display processing device according to the embodiment of the present invention will be described. First, an outline of a process in which the display processing section 17 superimposes the OSD image on the display image and causes the display device 70 to display the OSD image superimposed on the display image will be described. FIG. 2 is a diagram schematically showing a process when the display processing section 17 constituting the display processing device according to the embodiment of the present invention causes the display device 70 to display an image (a display image on which an OSD image is superimposed). An example of a display image according to display image data is shown in (a) of FIG. 2, an example of an OSD image according to OSD image data is shown in (b) of FIG. 2, and an example of an image to be displayed on the display device 70 is shown in (c) of FIG. 2.

As described above, the display processing section 17 acquires the display image data and the OSD image data recorded in the DRAM 30 according to the DMA transfer, superimposes the OSD image according to the OSD image data on the display image according to the acquired display image data, and causes the display device 70 to display the OSD image superimposed on the display image. More specifically, the OSD image according to the OSD image data as shown in (b) of FIG. 2 is superimposed on the display image according to the display image data as shown in (a) of FIG. 2, so that an image as shown in (c) of FIG. 2 is generated and the generated image is displayed on the display device 70.

In general, the OSD information is shown at a position where the OSD image does not overlap an imaged subject in the display image as in the example of the OSD image shown in (b) of FIG. 2. An example of the OSD image in which the OSD information is shown in upper-left and lower-right regions of the display image shown in (a) of FIG. 2 is shown in (b) of FIG. 2. For example, this is an example of an OSD image in which information of the remaining amount of power of the battery provided in the imaging device 1 is shown in the upper-left region of the display image and information of the photographing date and time when the captured image was obtained through photographing is shown in the lower-right region of the display image. Here, the transparency information included in the OSD image is information indicating a transparent pixel outside a region where the OSD information is displayed (a region where OSD information is shown in the upper-left and lower-right regions in the example of the OSD image shown in (b) of FIG. 2). Thereby, even when the OSD image is superimposed on the display image in the display processing section 17, the imaged subject in the display image is transmitted through the OSD image and displayed on the display device 70.

Meanwhile, in the conventional display processing device, all pixels having transparency information indicating transparent pixels included in the OSD image are also acquired. That is, in the conventional display processing device, data of two images (two frames) of the display image and the OSD image is acquired. Thus, in the conventional display processing device, an overload on the bus bandwidth is caused due to the DMA transfer in which the OSD image data is acquired from the DRAM. On the other hand, in the display processing section 17, as described above, the data of the OSD transparency map is acquired before the OSD image data is acquired from the DRAM 30 according to the DMA transfer, it is determined whether or not to acquire the OSD image data from the DRAM 30, and only the OSD image data determined to be acquired is acquired from the DRAM 30. In other words, although the display processing section 17 acquires all display image data for one frame from the DRAM 30 according to the DMA transfer, data having a smaller amount than all data for one frame is acquired as the OSD image data from the DRAM 30 according to the DMA transfer. Thereby, the display processing section 17 can minimize the amount of data transfers and reduce the overload on the bus bandwidth of the DRAM bus 11 regardless of the acquisition of image data for two frames of the display image and the OSD image from the DRAM 30.

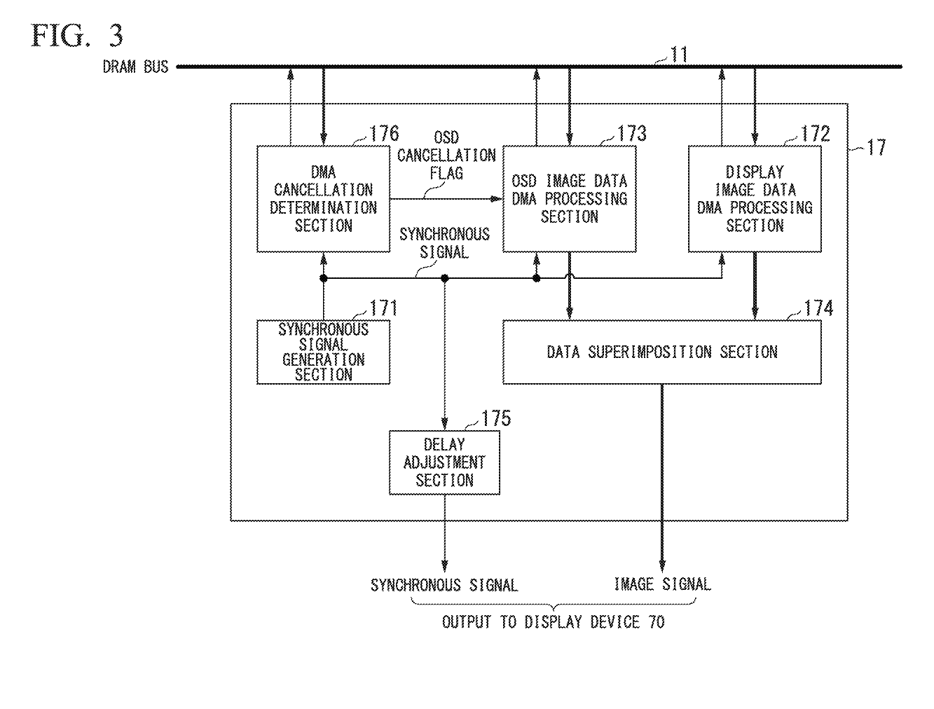

Next, the configuration and operation of the display processing section 17 will be described. FIG. 3 is a block diagram showing a schematic configuration of the display processing section 17 constituting the display processing device according to the embodiment of the present invention. The display processing section 17 includes a synchronous signal generation section 171, a display image data DMA processing section 172, an OSD image data DMA processing section 173, a data superimposition section 174, a delay adjustment section 175, and a DMA cancellation determination section 176.

On the basis of a clock signal (not shown), the synchronous signal generation section 171 is configured to generate a synchronous signal indicating a timing at which the display processing section 17 causes the display device 70 to display a display image according to display image data or an image obtained by superimposing the OSD image according to OSD image data on the display image according to the display image data. Here, the synchronous signal generated by the synchronous signal generation section 171 is a vertical synchronous signal VD, a horizontal synchronous signal HD, or the like corresponding to the display device 70. The synchronous signal generation section 171 outputs the generated synchronous signal to each of the display image data DMA processing section 172, the OSD image data DMA processing section 173, and the delay adjustment section 175.

The display image data DMA processing section 172 is a DMA processing section configured to acquire display image data from the DRAM 30 according to the DMA transfer on the basis of the synchronous signal output from the synchronous signal generation section 171. More specifically, the display image data DMA processing section 172, for example, acquires display image data from the DRAM 30 in predetermined units of DMA transfers during a period in which the horizontal synchronous signal HD output from the synchronous signal generation section 171 indicates that the display image according to the display image data is displayed. Here, the unit of the DMA transfer in the display image data DMA processing section 172 is a unit of a pixel included in the display image data or a unit obtained by combining a plurality of consecutive pixels, i.e., a unit of a burst transfer in the so-called DMA. Then, the display image data DMA processing section 172 outputs the acquired display image data to the data superimposition section 174.

Also, a timing at which the display image data DMA processing section 172 acquires the display image data from the DRAM 30 according to the DMA transfer is any timing as long as a signal of an image (hereinafter referred to as an “image signal”) to be displayed on the display device 70 can be provided until the display device 70 displays a display image according to the display image data. Thus, for example, if the display image data DMA processing section 172 is configured to include a line buffer capable of temporarily storing data for a predetermined line in an image displayed on the display device 70, display image data for a number of lines capable of being temporarily stored in the line buffer may be pre-acquired from the DRAM 30 according to the DMA transfer. In the case of this configuration, the display image data DMA processing section 172 outputs display image data temporarily stored in the line buffer to the data superimposition section 174 in accordance with a timing at which the display device 70 displays a display image according to the display image data.

On the basis of the synchronous signal output from the synchronous signal generation section 171, the DMA cancellation determination section 176 acquires data of an OSD transparency map from the DRAM 30 according to the DMA transfer before the OSD image data DMA processing section 173 acquires OSD image data from the DRAM 30 according to the DMA transfer and determines whether or not the OSD image data DMA processing section 173 has acquired the OSD image data from the DRAM 30 according to the DMA transfer. More specifically, for example, the DMA cancellation determination section 176 acquires the data of the OSD transparency map from the DRAM 30 in predetermined units of DMA transfers during a period in which the horizontal synchronous signal HD output from the synchronous signal generation section 171 indicates that a display image according to display image data is not displayed, i.e., a so-called horizontal blanking period. For example, the DMA cancellation determination section 176 acquires the data of the OSD transparency map from the DRAM 30 according to the DMA transfer of a predetermined unit at the start of the horizontal blanking period or at a timing when a predetermined time has elapsed from the start thereof. Here, similar to the unit of the DMA transfer in the display image data DMA processing section 172, the unit of the DMA transfer in the DMA cancellation determination section 176 may also be a unit of a pixel included in the data of the OSD transparency map or a unit of a burst transfer in DMA obtained by combining a plurality of consecutive pixels. The unit of the DMA transfer in the DMA cancellation determination section 176 may not be the same unit as the unit of the DMA transfer in the display image data DMA processing section 172.

Then, the DMA cancellation determination section 176 determines whether or not the data of each pixel included in the OSD image is pixel data for displaying the OSD information on the basis of the acquired data of the OSD transparency map. On the basis of a determination result thereof, the DMA cancellation determination section 176 determines whether or not the OSD image data DMA processing section 173 has acquired the pixel data for displaying the OSD information, i.e., OSD image data, from the DRAM 30 according to the DMA transfer. Then, the DMA cancellation determination section 176 outputs an OSD cancellation flag indicating the determination result to the OSD image data DMA processing section 173. The OSD cancellation flag output by the DMA cancellation determination section 176 is a signal indicating information of whether the OSD image data DMA processing section 173 performs the acquisition of OSD image data according to the DMA transfer or does not perform (cancels) the acquisition of OSD image data.

Also, the timing at which the DMA cancellation determination section 176 acquires the data of the OSD transparency map from the DRAM 30 according to the DMA transfer may be any timing before the OSD image data DMA processing section 173 acquires the OSD image data from the DRAM 30 according to the DMA transfer. Thus, for example, if the DMA cancellation determination section 176 is configured to include a line buffer capable of temporarily storing data for a predetermined line in an image displayed on the display device 70 as in the display image data DMA processing section 172, data of an OSD transparency map for a number of lines capable of being temporarily stored in the line buffer may be pre-acquired from the DRAM 30 according to the DMA transfer. In the case of this configuration, the DMA cancellation determination section 176 determines whether or not the OSD image data DMA processing section 173 has acquired OSD image data from the DRAM 30 according to DMA transfer on the basis of the data of the OSD transparency map temporarily stored in the line buffer corresponding to the OSD image data acquired by the OSD image data DMA processing section 173 from the DRAM 30 according to the DMA transfer. Then, in accordance with the timing at which the OSD image data DMA processing section 173 acquires the OSD image data from the DRAM 30 according to the DMA transfer, the DMA cancellation determination section 176 outputs the OSD cancellation flag indicating the determination result to the OSD image data DMA processing section 173.

The OSD image data DMA processing section 173 is a DMA processing section configured to acquire the OSD image data from the DRAM 30 according to the DMA transfer on the basis of the synchronous signal output from the synchronous signal generation section 171. At this time, the OSD image data DMA processing section 173 acquires OSD image data for which the OSD cancellation flag indicates that the OSD image data is acquired from the DRAM 30 according to the DMA transfer. More specifically, the OSD image data DMA processing section 173, for example, acquires the OSD image data indicated to be acquired by the OSD cancellation flag from the DRAM 30 in predetermined units of DMA transfers during a period in which the horizontal synchronous signal HD output from the synchronous signal generation section 171 indicates that the display image according to the display image data is displayed. Here, similar to the unit of the DMA transfer in the display image data DMA processing section 172 or the DMA cancellation determination section 176, the unit of the DMA transfer in the OSD image data DMA processing section 173 may also be a unit of a pixel included in the OSD image data or a unit of a burst transfer in DMA obtained by combining a plurality of consecutive pixels. Also, the unit of the DMA transfer in the OSD image data DMA processing section 173 may not be the same unit as the unit of the DMA transfer in the display image data DMA processing section 172 or the DMA cancellation determination section 176. Then, the OSD image data DMA processing section 173 outputs the acquired OSD image data to the data superimposition section 174.

Also, a timing at which the OSD image data DMA processing section 173 acquires the OSD image data from the DRAM 30 according to the DMA transfer may be any timing as long as an image signal to be displayed on the display device 70 can be provided until the display device 70 displays a display image according to the display image data obtained by superimposing an OSD image according to the OSD image data as in the display image data DMA processing section 172. Thus, for example, if the OSD image data DMA processing section 173 is configured to include a line buffer capable of temporarily storing data for a predetermined line in an image displayed on the display device 70 as in the display image data DMA processing section 172, OSD image data for a number of lines capable of being temporarily stored in the line buffer may be pre-acquired from the DRAM 30 according to the DMA transfer. In the case of this configuration, similar to the display image data DMA processing section 172, the OSD image data DMA processing section 173 outputs OSD image data temporarily stored in the line buffer to the data superimposition section 174 in accordance with a timing at which the display device 70 displays a display image according to display image data on which an OSD image according to the OSD image data is superimposed.

Also, as described above, the display processing section 17 acquires only OSD image data for which the OSD cancellation flag indicates that the OSD image data is acquired from the DRAM 30. That is, the OSD image data acquired from the DRAM 30 by the OSD image data DMA processing section 173 according to the DMA transfer is data corresponding to a region where the OSD information is displayed and is only data corresponding to pixels for which transparency information included in the OSD image indicates non-transparency or translucency. Thus, the OSD image data acquired from the DRAM 30 by the OSD image data DMA processing section 173 according to the DMA transfer may be less than data for one line in the image displayed on the display device 70. Therefore, when the OSD image data is output to the data superimposition section 174, the OSD image data DMA processing section 173 outputs data of pseudo-pixels instead of data of pixels for which transparency information included in the OSD image which is not acquired from the DRAM 30 according to the DMA transfer indicates transparency, i.e., data of transparent pixels which do not display the OSD information. In other words, the OSD image data DMA processing section 173 supplements data of transparent pixels that do not display the OSD information as those acquired from the DRAM 30 according to the DMA transfer, and outputs data of all pixels of the OSD image to the data superimposition section 174. Here, because the data of the pseudo-pixels supplemented by the OSD image data DMA processing section 173 and output to the data superimposition section 174 is pixel data that is not displayed (not reflected) as OSD information even when the pixel data is superimposed on the display image, it is only necessary for the data of the pseudo-pixels to be data including at least transparency information indicating that pixels thereof are transparent.

The data superimposition section 174 is configured to generate an image signal for causing the display device 70 to display a display image according to display image data by performing predetermined image processing on the display image data output from the display image data DMA processing section 172. Also, when the OSD image data is output from the OSD image data DMA processing section 173, the data superimposition section 174 is configured to generate an image signal by performing image processing of superimposing an OSD image according to the OSD image data on the display image according to the display image data. The data superimposition section 174 outputs the generated image signal to the display device 70. Thereby, the display device 70 displays the display image according to the display image data or the display image according to the display image data on which the OSD image according to the OSD image data is superimposed.

The delay adjustment section 175 delays each synchronous signal output from the synchronous signal generation section 171 by a time corresponding to a delay of processing of the display image data DMA processing section 172, the OSD image data DMA processing section 173, and the data superimposition section 174 and outputs the delayed synchronous signal to the display device 70. That is, the delay adjustment section 175 delays each synchronous signal output from the synchronous signal generation section 171 in accordance with a timing of the image signal output from the data superimposition section 174 to the display device 70, and outputs the delayed synchronous signal to the display device 70.

According to such a configuration, in the display processing section 17, the DMA cancellation determination section 176 acquires data of an OSD transparency map before the OSD image data DMA processing section 173 acquires the OSD image data from the DRAM 30 according to the DMA transfer and determines whether or not the data of each pixel included in the OSD image is pixel data for displaying the OSD information. Then, in the display processing section 17, the OSD image data DMA processing section 173 acquires only pixel data included in the OSD image determined to be pixel data for displaying the OSD information by the DMA cancellation determination section 176 from the DRAM 30 according to the DMA transfer. Thereby, the display processing section 17 can reduce an amount of data when the OSD image data is acquired as compared with an amount of data when data of all pixels of the OSD image is acquired in the conventional display processing device and can reduce an overload on the bus bandwidth of the DRAM bus 11. Thereby, the display processing section 17 can cope with the display of images on a high-definition display device more easily than when the conventional display processing device supports the display of images on a higher-definition display device.

Next, the OSD image data and the OSD transparency map generated by the OSD data generation section 16 will be described. First, a configuration of the OSD image data generated by the OSD data generation section 16 will be described. Also, in the following description, an example in which the display device 70 displays an image of a VGA size, i.e., an image of 640 pixels×480 lines, will be described. Also, in the following description, an example in which a type of OSD image data generated by the OSD data generation section 16, i.e., the data of each pixel included in the OSD image, is 8-bit data, will be described. Also, in the following description, an example in which a unit of a DMA transfer when each of the display image data DMA processing section 172, the OSD image data DMA processing section 173, and the DMA cancellation determination section 176 provided in the display processing section 17 acquires corresponding data from the DRAM 30 is a unit of a burst transfer in which consecutive data of 512 bits is combined, i.e., a burst length in the DMA transfer (a DMA burst length) is 512 bits, will be described.

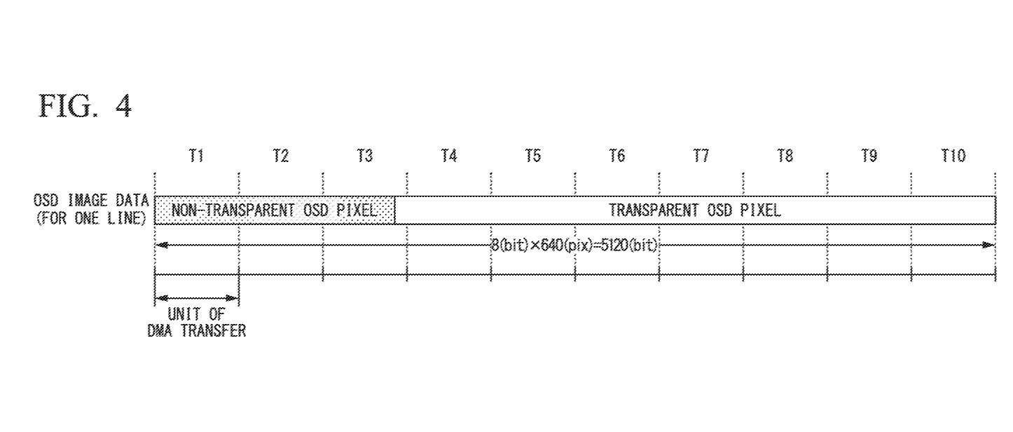

FIG. 4 is a diagram schematically showing an example of OSD image data generated by the OSD data generation section 16 constituting the display processing device according to the embodiment of the present invention. In FIG. 4, an example of OSD image data for a first line in data of one frame of the OSD image shown in (b) of FIG. 2 is shown. In the OSD image shown in (b) of FIG. 2, the OSD information is displayed in upper-left and lower-right regions of the display image shown in (a) of FIG. 2. Accordingly, as shown in FIG. 4. OSD image data for the first line generated by the OSD data generation section 16 is bitmap data in which data of a non-transparent (or translucent) pixel (a non-transparent OSD pixel) for displaying the OSD information in the upper-left region is arranged at the beginning (the left) thereof and data of a transparent pixel (a transparent OSD pixel) for transmitting pixel data of a subject included in the display image without displaying the OSD information is arranged thereafter.

The total number of bits of OSD image data for one line generated by the OSD data generation section 16 is the number of bits calculated by multiplying the number of bits of data of each pixel included in the OSD image by the number of pixels for one line to be displayed by the display device 70 and is represented by the following Equation (1).

(Number of bits of pixel data)×(Number of pixels for one line)=8 (bits)×640 (pixels)=5120 (bits) (1)

When the OSD image data DMA processing section 173 acquires data of all pixels of the OSD image of that number of bits from the DRAM 30 according to the DMA transfer, the OSD image data DMA processing section 173 performs the DMA transfer for the number of times represented by the following Equation (2) by dividing the number of bits of data of all the pixels (the total number of pixels) by the unit of the DMA transfer (the DMA burst length).

(Total number of bits)/(DMA burst length)=5120 (bits)/512 (bits)=10 (times) (2)

In FIG. 4, a state in which the OSD image data DMA processing section 173 acquires OSD image data for one line in 10 DMA transfers which are DMA transfers T1 to T10 is shown. The OSD image data DMA processing section 173 sequentially outputs the OSD image data for one line acquired according to the 10 DMA transfers to the data superimposition section 174. Thereby, the data superimposition section 174 is configured to generate an image signal obtained by superimposing the OSD image data corresponding to each pixel output by the OSD image data DMA processing section 173 on the display image according to the display image data and outputs the image signal to the display device 70.

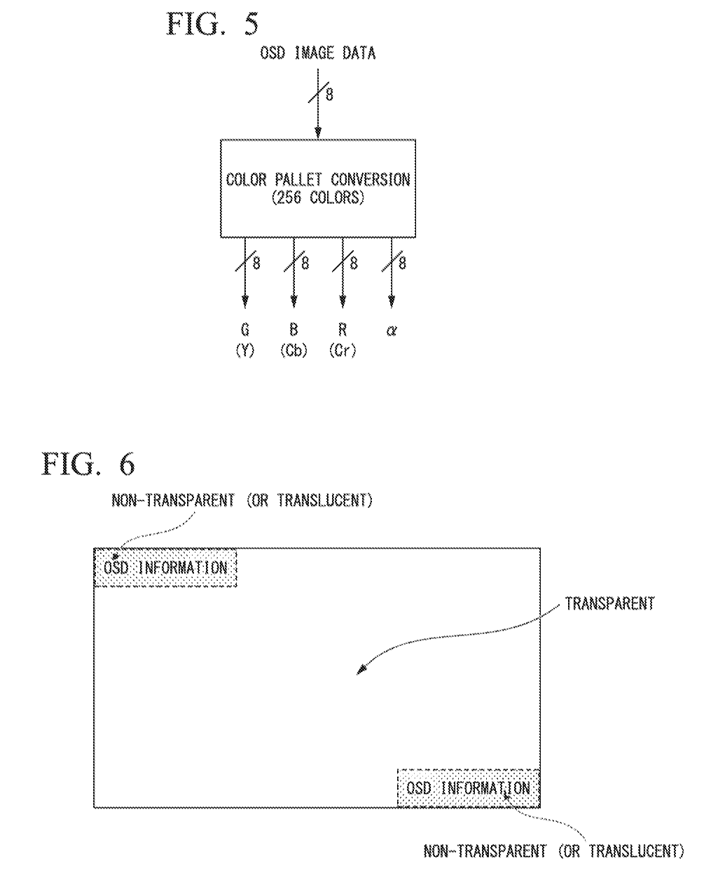

Here, an example of the process of the data superimposition section 174 on the OSD image data generated by the OSD data generation section 16 will be described. FIG. 5 is a diagram schematically showing an example of a process of converting OSD image data in the data superimposition section 174 provided in the display processing section 17 constituting the display processing device according to the embodiment of the present invention. Here, as described above, the OSD image data DMA processing section 173 outputs OSD image data in which data of each pixel generated by the OSD data generation section 16 is 8-bit data to the data superimposition section 174. A type of OSD image data is a type in which a color of each pixel included in the OSD image is represented by 256 colors, i.e., a type of data of a so-called 256-color palette address, according to 8-bit data. An example of a process in which the data superimposition section 174 converts 8-bit data representing the color of each pixel into color information and transparency information is shown in FIG. 5. The data superimposition section 174 converts 8-bit data of each pixel included in the OSD image input from the OSD image data DMA processing section 173 into color information and transparency information for each pixel.

In the example shown in FIG. 5, an example in which the data superimposition section 174 converts 8-bit pixel data included in the OSD image into color information such as RGB data representing colors of red (R), green (G), and blue (B) or YCbCr data of a YC-422 dot sequential type of Y (luminance), Cb (color difference: blue) and Cr (color difference: red) and transparency information α indicating whether a pixel is transparent or non-transparent (translucent according to some cases) is shown. More specifically, in the example shown in FIG. 5, an example in which 8-bit data is input as an address and the 8-bit data is converted into G (Y) data, B (Cb) data, R (Cr) data and transparency information α by using table information, i.e., a so-called lookup table (LUT), in which color information (RGB data or YCbCr data) and transparency information α are exclusively assigned to each address is shown. Also, because a method of converting the 8-bit data into the color information such as the RGB data or the YCbCr data and the transparency information α is a method using existing technology, a detailed description thereof will be omitted.

On the basis of the transparency information for each pixel obtained through conversion, the data superimposition section 174 is configured to generate an image signal by superimposing the color information (RGB data or YCbCr data) for each pixel obtained through conversion on a corresponding pixel of the display image according to the display image data.

Also, the number of bits of the data of each pixel in the OSD image data, i.e., the type of OSD image data, is not limited to the above-described type of 8-bit color palette address data. For example, the type may be a type of data in which the number of bits of the data of the color information and the transparency information of each pixel in the OSD image data is 8 bits. In this case, the color information and the transparency information can be converted into 256 gradations. For example, the transparency information can be converted into a value of the gradation or percentage of transparency such as “0” indicating the transparency, “1” to “254” indicating the translucency, and “255” indicating the non-transparency. Also, for example, the type may be a type for transferring data of the color information and transparency information represented by the OSD image data as it is according to the DMA transfer without adopting a configuration for converting the OSD image data. In this case, the data superimposition section 174 superimposes the data on the corresponding pixel of the display image according to the display image data without converting the data of each pixel included in the OSD image output from the OSD image data DMA processing section 173.

Next, the configuration of the OSD transparency map generated by the OSD data generation section 16 will be described. FIG. 6 is a diagram schematically showing an example of the OSD transparency map generated by the OSD data generation section 16 constituting the display processing device according to the embodiment of the present invention. In FIG. 6, an example of the OSD transparency map corresponding to the data of one frame of the OSD image shown in (b) of FIG. 2 is shown. In the OSD image shown in (b) of FIG. 2, the OSD information is displayed in the upper-left and lower-right regions of the display image shown in (a) of FIG. 2. Accordingly, as shown in FIG. 6, the OSD transparency map generated by the OSD data generation section 16 also becomes bitmap data for one frame indicating that the upper-left and lower-right regions are non-transparent or translucent.

As described above, because the general OSD image displays the OSD information at a position which does not overlap the imaged subject in the display image, the OSD transparency map is a region having a major part which is transparent within a region for one frame as shown in FIG. 6. That is, a region other than the upper-left and lower-right regions for displaying the OSD information in the display image shown in (a) of FIG. 2 is a transparent region for transmitting the image of the imaged subject in the display image.

Next, the timings at which the OSD data generation section 16 is configured to generate the OSD image data or the OSD transparency map will be described. As described above, the OSD data generation section 16 is configured to generate OSD image data and an OSD transparency map according to the operation mode or settings of the imaging device 1. Thus, the timings at which the OSD data generation section 16 is configured to generate the OSD image data and the OSD transparency map are when the operation mode or setting of the imaging device 1 is changed. However, the display processing section 17 (more specifically, the OSD image data DMA processing section 173 provided in the display processing section 17) starts the DMA transfer for acquiring OSD image data for one frame previously generated and stored (written) in the DRAM 30 and the OSD data generation section 16 does not generate new OSD image data when the acquisition of OSD image data for one frame is not completed. This is because, when the OSD image data DMA processing section 173 has not completed the acquisition of OSD image data for one frame previously generated and stored (written) in the DRAM 30, the OSD information currently displayed on the display device 70 is changed midway if the OSD data generation section 16 is configured to generate new OSD image data.

Also, likewise, the display processing section 17 (more specifically, the DMA cancellation determination section 176 provided in the display processing section 17) starts the DMA transfer for acquiring an OSD transparency map for one frame previously generated and stored (written) in the DRAM 30 and the OSD data generation section 16 does not generate an OSD transparency map corresponding to new OSD image data even when the acquisition of the OSD transparency map for one frame is not completed.

Thus, the OSD data generation section 16 is configured to generate the OSD image data or the OSD transparency map during a period in which the OSD image data DMA processing section 173 and the DMA cancellation determination section 176 do not acquire the OSD image data and the OSD transparency map according to the DMA transfer.

As a period during which the OSD image data DMA processing section 173 and the DMA cancellation determination section 176 do not perform the DMA transfer, for example, a period during which a display image according to the display image data or an OSD image according to the OSD image data is not displayed on the display device 70, i.e., a so-called blanking period, is considered. However, as described above, because the DMA cancellation determination section 176 acquires data of the OSD transparency map from the DRAM 30 according to the DMA transfer during the horizontal blanking period, a blanking period during which the OSD data generation section 16 is configured to generate the OSD image data or the OSD transparency map becomes a vertical blanking period.

The vertical blanking period can be determined by the vertical synchronous signal VD generated by the synchronous signal generation section 171 provided in the display processing section 17. Thus, the OSD data generation section 16 determines the vertical blanking period on the basis of the vertical synchronous signal VD output by the synchronous signal generation section 171 provided in the display processing section 17 constituting the display processing device according to the embodiment of the present invention and is configured to generate OSD image data or an OSD transparency map during the determined vertical blanking period. In this case, the OSD data generation section 16 is configured to receive the vertical synchronous signal VD output by the synchronous signal generation section 171.

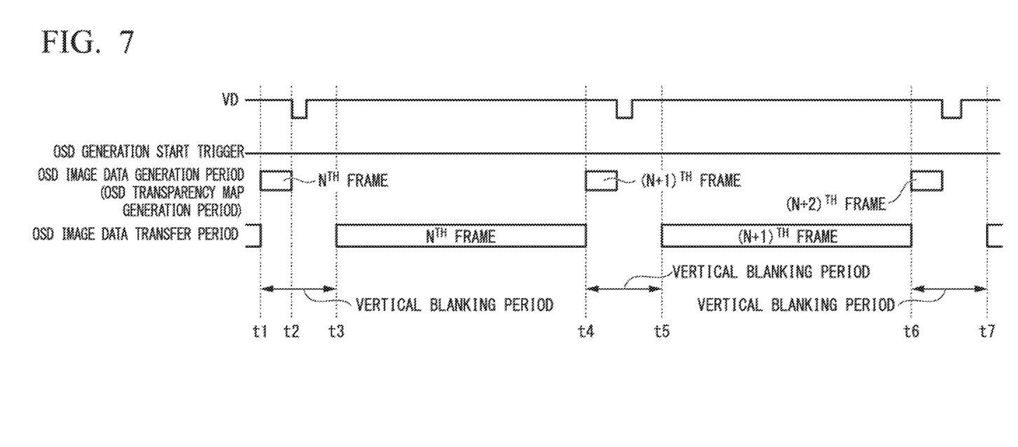

FIG. 7 is a timing chart showing an example of the timings at which the OSD data generation section 16 constituting the display processing device according to the embodiment of the present invention is configured to generate OSD image data and an OSD transparency map. In FIG. 7, an example of the timings when the OSD data generation section 16 starts generating the OSD image data and the OSD transparency map from the timing of the start of the vertical blanking period is shown. More specifically, in FIG. 7, an example of the timings at which the OSD data generation section 16 starts the generation of the OSD image data and the OSD transparency map from a timing of an OSD generation start trigger signal indicating the timing of the start of the vertical blanking period determined on the basis of the vertical synchronous signal VD is shown. Also, the timing chart shown in FIG. 7 is an example in which the OSD data generation section 16 is configured to generate the OSD image data and the OSD transparency map every frame.

The OSD data generation section 16 starts the generation of OSD image data of an N^{th} flame and an OSD transparency map corresponding to the OSD image data of the N^{th} frame in accordance with the OSD generation start trigger signal output at a timing t1 of the start of the first vertical blanking period starting with the completion of the acquisition of the OSD image data from the DRAM 30 according to the DMA transfer in the display processing section 17. Then, the OSD data generation section 16 completes (ends) the generation of the OSD image data of the N^{th} frame and the OSD transparency map corresponding to the OSD image data of the N^{th} frame until a timing t3 at which the vertical blanking period ends, i.e., the display processing section 17 starts the acquisition of the OSD image data of the N^{th} frame and the OSD transparency map corresponding to the OSD image data of the N^{th} frame according to the DMA transfer from the DRAM 30 according to the DMA transfer. In the timing chart shown in FIG. 7, an example in which the generation of the OSD image data of the N^{th} frame and the OSD transparency map corresponding to the OSD image data of the N^{th} frame is completed (ended) at a timing t2 earlier than the timing t3 at which the vertical blanking period ends is shown. As described above, the OSD data generation section 16 causes the DRAM 30 to record the generated OSD image data and the data of the OSD transparency map in association.

Thereafter, the OSD data generation section 16 is configured to generate the OSD image data and the OSD transparency map of the next frame during each vertical blanking period. More specifically, during a second vertical blanking period which starts at a timing t4 and ends at a timing t5, the OSD data generation section 16 is configured to generate the OSD image data of an (N+1)^{th} frame and the OSD transparency map corresponding to the OSD image data of the (N+1)^{th} frame and causes the DRAM 30 to record the generated OSD image data and data of the generated OSD transparency map in association. Also, the OSD data generation section 16 is configured to generate OSD image data of an (N+2)^{th} frame and an OSD transparency map corresponding to the OSD image data of the (N+2)^{th} frame during a third vertical blanking period which starts at a timing t6 and ends at a timing t7 and causes the DRAM 30 to record the generated OSD image data and data of the generated OSD transparency map in association.

At such a timing, the OSD data generation section 16 is configured to generate the OSD image data and the OSD transparency map during the vertical blanking period in which the display processing section 17 (more specifically, the OSD image data DMA processing section 173 and the DMA cancellation determination section 176) does not perform the acquisition of the OSD image data and the OSD transparency map is not performed according to the DMA transfer.

Also, the timing of the start of the vertical blanking period may also be a timing at which another component provided in the image processing device 10 starts the DMA transfer. In this case, the OSD data generation section 16 may start the generation of the OSD image data and the OSD transparency map from a timing at which a predetermined time has elapsed from the start of the vertical blanking period. Here, the predetermined time is, for example, a time in which it is determined that the DMA transfer of the other component provided in the image processing device 10 has been completed.

Also, the timing at which the OSD data generation section 16 is configured to generate the OSD image data and the OSD transparency map is not limited to that during the above-described vertical blanking period. That is, the OSD data generation section 16 may generate the OSD image data and the OSD transparency maps at any timing during a period in which the OSD image data DMA processing section 173 and the DMA cancellation determination section 176 do not perform the acquisition of the OSD image data and the OSD transparency map according to the DMA transfer.

For example, the image processing device 10 includes a DRAM bus arbitration section 13. As described above, the DRAM bus arbitration section 13 arbitrates a DMA request for the DRAM 30 from each component within the image processing device 10 connected to the DRAM bus 11. Thus, the DRAM bus arbitration section 13 can also determine a period during which the OSD image data DMA processing section 173 and the DMA cancellation determination section 176 do not perform the DMA transfer. This is because the general DRAM bus arbitration section also has a function of measuring (monitoring) the amount of data transfers for each predetermined period, i.e., a so-called bus bandwidth monitoring function, in addition to a function of arbitrating a request for accessing the DRAM from the components connected to the data bus (a DMA request) on the basis of a preset rule. Thus, the DRAM bus arbitration section 13 also divides a period of one frame for displaying an image on the display device 70 into equal interval periods and measures (monitors) the amount of data transfers of the DRAM bus 11 in each division period by using the bus bandwidth monitoring function, thereby determining a period in which the amount of data transfers between each component in the image processing device 10 and the DRAM 30 is small, i.e., a period in which the transfer of data via the DRAM bus 11 is small.

Then, the OSD data generation section 16 can generate the OSD image data and the OSD transparency map during the period in which the transfer of data via the DRAM bus 11 is small on the basis of a result of measurement (monitoring) of the DRAM bus arbitration section 13.

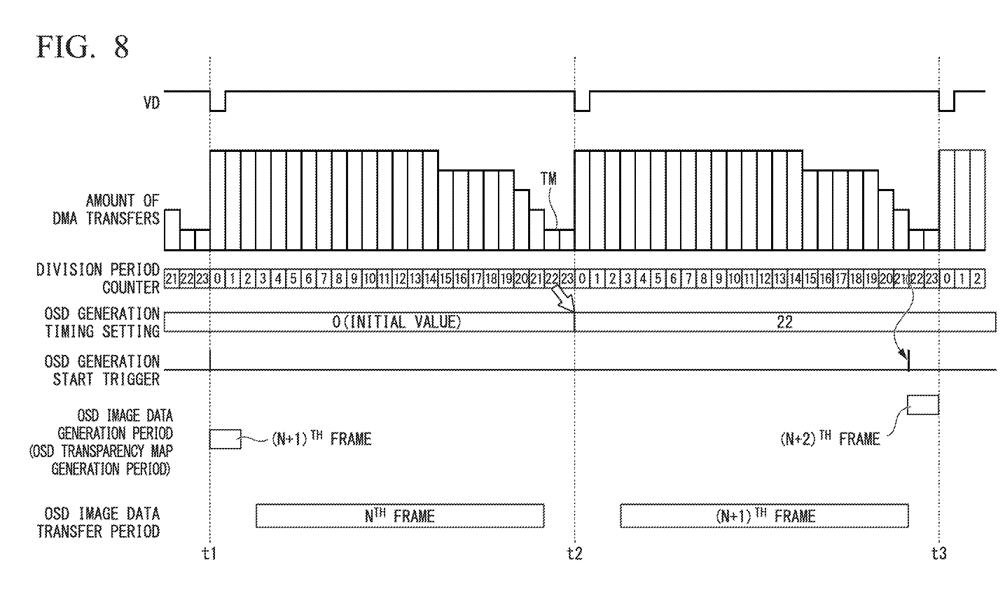

FIG. 8 is a timing chart showing another example of timings at which the OSD data generation section 16 constituting the display processing device according to the embodiment of the present invention is configured to generate OSD image data and an OSD transparency map. In FIG. 8, an example of a timing when periods (division periods) obtained by dividing a period of one frame for causing the display device 70 to display an image into 23 parts are set as periods in which the DRAM bus arbitration section 13 measures (monitors) the amount of data transfers (the amount of DMA transfers) and the OSD data generation section 16 is configured to generate the OSD image data and the OSD transparency map during a division period in which the amount of DMA transfers is small is shown. More specifically, in FIG. 8, an example of a timing when a timing of a falling edge of the vertical synchronous signal VD is set as a reference timing and a division period in which the amount of DMA transfers measured (monitored) by the DRAM bus arbitration section 13 is smallest is set as a division period in which the OSD data generation section 16 starts the generation of the OSD image data and the OSD transparency map during a period of the next frame is shown. Also, the timing chart shown in FIG. 8 is an example in which the OSD data generation section 16 is configured to generate the OSD image data and the OSD transparency map every frame.

Also, the display processing device according to the embodiment of the present invention which performs the operation of the timing chart shown in FIG. 8 is configured to cause the DRAM 30 to record OSD image data and an OSD transparency map for two frames in the DRAM 30 and alternately perform switching between the OSD image data and the OSD transparency map to be acquired when the OSD image data and an OSD transparency map are acquired from the DRAM 30 according to the DMA transfer. According to this configuration, the OSD data generation section 16 can also generate new OSD image data and a new OSD transparency map and cause the DRAM 30 to record the new OSD image data and the new OSD transparency map during a period in which the OSD image data DMA processing section 173 and the DMA cancellation determination section 176 acquire the OSD image data and the OSD transparency map from the DRAM 30 by performing the DMA transfer.

First, the OSD data generation section 16 starts the counting of the number of division periods from the timing t1 of the falling edge of the first vertical synchronous signal VD corresponding to the display of the OSD image data of the N^{th} frame on the display device 70. At the same time, the DRAM bus arbitration section 13 starts the measurement (monitoring) of the amount of DMA transfers during the period of a current frame for causing the display device 70 to display the OSD image according to the OSD image data of the N^{th} frame. The DRAM bus arbitration section 13 sequentially outputs information of the amount of DMA transfers measured (monitored) during each division period to the OSD data generation section 16.

Also, in accordance with the OSD generation start trigger signal output on the basis of an initial value (=“0”) of the OSD generation timing setting, the OSD data generation section 16 starts the generation of the OSD image data of the (N+1)^{th} frame and the OSD transparency map corresponding to the OSD image data of the (N+1)^{th} frame to be displayed on the display device 70 during a period of the next frame subsequent to a period of the current frame (the N^{th} frame). When the generation of the OSD image data and the OSD transparency map of the (N+1)^{th} frame are completed (ended), the OSD data generation section 16 causes the DRAM 30 to record the generated OSD image data of the (N+1)^{th} frame and the data of the OSD transparency map corresponding to the OSD image data of the (N+1)^{th} frame in association.

Thereafter, the OSD data generation section 16 determines a division period having the smallest amount of DMA transfers on the basis of information of the amount of DMA transfers during each division period sequentially output from the DRAM bus arbitration section 13. In the example shown in FIG. 8, a case in which the OSD data generation section 16 determines that a division period TM corresponding to the count value=“22” of a division period counter is a division period with the smallest amount of DMA transfers is shown. At the timing t2 of the falling edge of the second vertical synchronous signal VD corresponding to the display of the OSD image data of the (N+1)^{th} frame on the display device 70, the OSD data generation section 16 sets the count value=“22” corresponding to the division period TM determined to have the smallest amount of DMA transfer as an OSD generation timing setting indicating a timing at which the generation of OSD image data and an OSD transparency map of an (N+2)^{th} frame is started during a period of the next frame.

Thereby, the OSD generation start trigger signal is not output on the basis of the OSD generation timing setting at the timing t2 and the OSD generation start trigger signal is output when the count value of the division period starting from the timing t2 of the falling edge of the second vertical synchronous signal VD corresponding to the display of the OSD image data of the (N+1)^{th} frame on the display device 70 becomes the OSD generation timing setting=“22”. Thereby, the OSD data generation section 16 starts the generation of OSD image data of the (N+2)^{th} frame and an OSD transparency map corresponding to OSD image data of the (N+2)^{th} frame to be displayed on the display device 70 during a period of the next frame subsequent to a period of a current frame (the (N+1)^{th} frame) in accordance with the OSD generation start trigger signal output on the basis of the OSD generation timing setting=“22”. When the generation of the OSD image data and the OSD transparency map of the (N+2)^{th} frame is completed (ended), the OSD data generation section 16 causes the DRAM 30 to record the generated OSD image data and data of the generated OSD transparency map of the (N+2)^{th} frame in association.

Thereafter, likewise, the OSD data generation section 16 is configured to generate OSD image data and an OSD transparency map to be displayed on the display device 70 during the next frame period from the division period in which the amount of DMA transfers measured (monitored) by the DRAM bus arbitration section 13 is smallest and causes the DRAM 30 to record the generated OSD image data and data of the generated OSD transparency map in association.

At such a timing, the OSD data generation section 16 is configured to generate OSD image data and an OSD transparency map to be acquired according to the DMA transfer and displayed on the display device 70 by the display processing section 17 (more specifically, the OSD image data DMA processing section 173 and the DMA cancellation determination section 176).

The display processing section 17 minimizes the amount of data transfers when the OSD image data is acquired from the DRAM 30 according to the DMA transfer on the basis of the OSD transparency map generated by the OSD data generation section 16 in this manner. In other words, the display processing section 17 reduces an overload on the bus bandwidth of the DRAM buts 11 by acquiring only OSD image data of the non-transparent or translucent upper-left and lower-right regions indicated by the OSD transparency map on the basis of the OSD transparency map as shown in FIG. 6. More specifically, the OSD image data DMA processing section 173 minimizes the amount of unnecessary transfers of OSD image data and reduces an overload on the bus bandwidth of the DRAM bus 11 when the OSD image data is acquired from the DRAM 30 according to the DMA transfer by preventing (cancelling) the acquisition of transparent pixel data included in the OSD image in accordance with an OSD cancellation flag output from the DMA cancellation determination section 176 on the basis of the OSD transparency map as shown in FIG. 6.

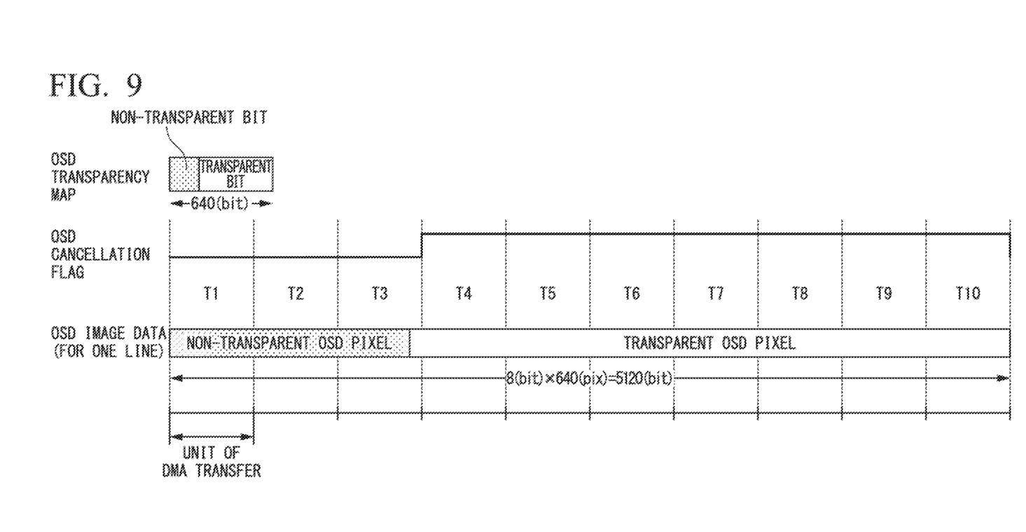

Next, the operation of the display processing section 17 will be described. FIG. 9 is a diagram showing the operation of the display processing section 17 constituting the display processing device according to the embodiment of the present invention. In FIG. 9, an example of a DMA transfer in the display processing section 17 when OSD image data for a first line shown in FIG. 4 is acquired from the DRAM 30 is shown. Also, in the following description, an example in which the display device 70 displays an image of a VGA size (640 pixels×480 lines) and a unit of a DMA transfer when each of the OSD image data DMA processing section 173 and the DMA cancellation determination section 176 provided in the display processing section 17 acquires corresponding data from the DRAM 30 according to the DMA transfer is a unit of a burst transfer having a DMA burst length=512 bits will be described.

As described above, before the OSD image data DMA processing section 173 acquires OSD image data from the DRAM 30 according to the DMA transfer, the DMA cancellation determination section 176 acquires data of an OSD transparency map from the DRAM 30 according to the DMA transfer. Here, the OSD transparency map is 1-bit data indicating whether or not each pixel included in the OSD image is transparent. Thus, the number of bits of the OSD transparency map for one line corresponding to the OSD image data for one line acquired by the DMA cancellation determination section 176 is the number of bits=640 bits which is the same as the number of pixels included in the OSD image for one line.

The DMA cancellation determination section 176 determines whether or not the OSD image data DMA processing section 173 has acquired the OSD image data from the DRAM 30 according to the DMA transfer on the basis of the data of the OSD transparency map of 640 bits acquired in advance. More specifically, as shown in FIG. 9, the data of the OSD transparency map of 640 bits includes a non-transparent bit of a value (for example, “1”) indicating that the pixel included in the OSD image is a non-transparent OSD pixel and a transparent bit of a value (for example, “0”) indicating that the pixel included in the OSD image is a transparent OSD pixel. On the basis of the non-transparent bit and the transparent bit, the DMA cancellation determination section 176 outputs an OSD cancellation flag indicating whether or not to perform the acquisition of the OSD image data to the OSD image data DMA processing section 173.

Also, the unit of the DMA transfer of the OSD image data DMA processing section 173 is a unit of a burst transfer having a DMA burst length=512 bits and a setting for performing 10 DMA transfers to acquire data of all pixels of an OSD image for one line is made. Thus, the DMA cancellation determination section 176 divides the acquired data of the OSD transparency map of 640 bits by the number of data corresponding to the unit of the DMA transfer in the OSD image data DMA processing section 173 and determines whether or not to perform the acquisition of the OSD image data for each unit of the DMA transfer of the OSD image data DMA processing section 173 to output the OSD cancellation flag. More specifically, the DMA cancellation determination section 176 divides the data of the OSD transparency map of 640 bits acquired in advance for every 64 bits corresponding to the unit of the burst transfer in which the OSD image data DMA processing section 173 performs the DMA transfer, and determines whether or not to perform the acquisition of the OSD image data for each division to output the OSD cancellation flag. Here, if all data of the OSD transparency map included in the 64-bit division is transparent bit, the DMA cancellation determination section 176 determines not to perform the acquisition of the OSD image data in a unit of a DMA transfer corresponding to the division, i.e., determines to cancel the DMA transfer of the OSD image data DMA processing section 173. On the other hand, if any data of the OSD transparency map, which is a non-transparent bit, is included in the 64-bit division, the DMA cancellation determination section 176 determines not to cancel the DMA transfer of the OSD image data DMA processing section 173 in the unit of the DMA transfer corresponding to the division, i.e., determines to perform the acquisition of the OSD image data. In FIG. 9, an example of the OSD cancellation flag indicating that the acquisition of OSD image data is performed by a “Low” level and indicating that the acquisition of the OSD image data is not performed (cancelled) by a “High” level is shown.

When the OSD cancellation flag output from the DMA cancellation determination section 176 indicates the “Low” level indicating that the acquisition of the OSD image data is performed, the OSD image data DMA processing section 173 acquires the OSD image data from the DRAM 30 by performing the DMA transfer in the unit of the burst transfer of the DMA burst length=512 bits. In one example of the DMA transfer in the display processing section 17 shown in FIG. 9, the OSD image data DMA processing section 173 acquires the OSD image data from the DRAM 30 according to DMA transfers T1 to T3 when the OSD cancellation flag indicates the “Low” level. In other words, the OSD image data DMA processing section 173 cancels the acquisition of the OSD image data from the DRAM 30 according to DMA transfers T4 to T10 when the OSD cancellation flag indicates the “High” level indicating that the acquisition of the OSD image data is not performed.

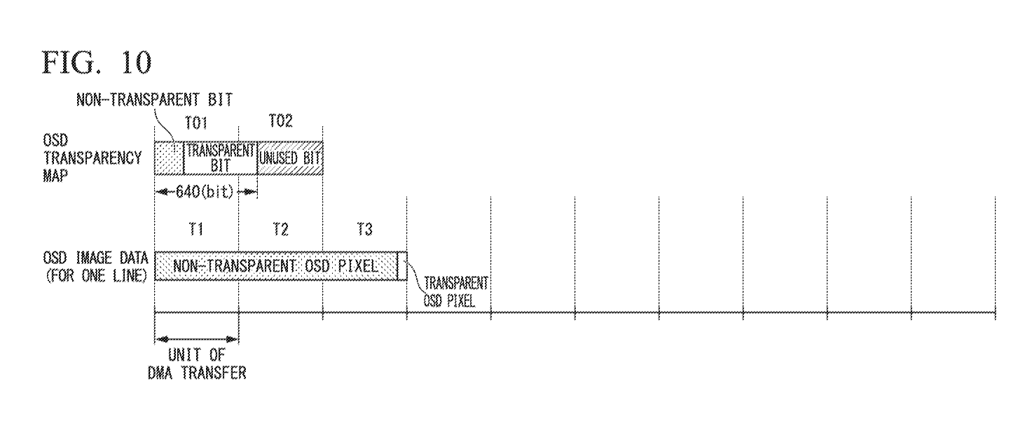

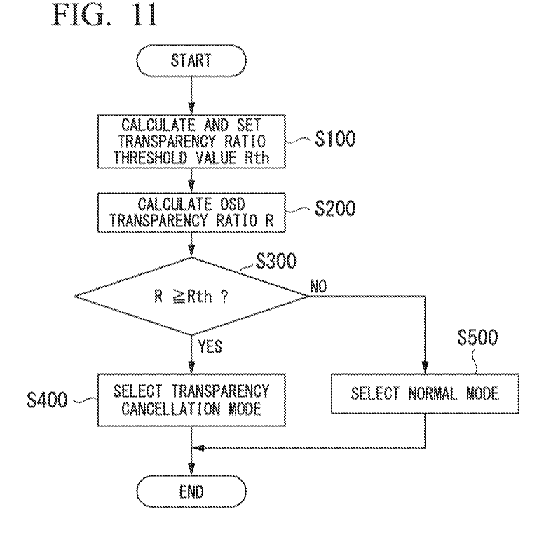

Here, the DMA transfer in the operation of the display processing section 17 shown in FIG. 9 will be described. FIG. 10 is a diagram schematically showing a state of the DMA transfer of the display processing section 17 constituting the display processing device according to the embodiment of the present invention. FIG. 10 shows a state of a DMA transfer when the OSD image data for the first one line shown in FIG. 9 is acquired from the DRAM 30.

Here, the unit of the DMA transfer in the DMA cancellation determination section 176 is a unit of a burst transfer with a DMA burst length=512 bits. Thus, as shown in FIG. 10, when the DMA cancellation determination section 176 acquires the 640-bit OSD transparency map from the DRAM 30, two DMA transfers (DMA transfers T01 and T02) are performed.

Also, when the DMA cancellation determination section 176 performs two DMA transfers in units of burst transfers each having a DMA burst length=512 bits, the number of bits of the OSD transparency map acquired from the DRAM 30 is 1024 bits, and is larger than the number of bits (=640 bits) of the OSD transparency map for one line. Thus, the DMA cancellation determination section 176 determines the data of the OSD transparency map after a 641^{st} bit as data of an unused bit which is not used when it is determined whether or not to perform the acquisition of OSD image data and discards the acquired data (the bit value).

Then, the DMA cancellation determination section 176 generates an OSD cancellation flag on the basis of valid data of the OSD transparency map of 640 bits and outputs the generated OSD cancellation flag to the OSD image data DMA processing section 173.

Thereby, as shown in FIG. 10, in accordance with the OSD cancellation flag output from the OSD image data DMA processing section 173, the OSD image data DMA processing section 173 performs three DMA transfers from the DMA transfer T1 to the DMA transfer T3 and acquires non-transparent OSD pixel data included in the OSD image data for one line from the DRAM 30.

The number of DMA transfers required for acquiring the non-transparent OSD pixel data included in the OSD image data for one line is five including two transfers for acquiring the OSD transparency map in the DMA cancellation determination section 176 and three transfers for acquiring non-transparent OSD pixel data included in the OSD image data for one line in the OSD image data DMA processing section 173. That is, it is necessary to perform 10 DMA transfers so that the OSD image data DMA processing section 173 acquires data of all pixels of the OSD image for one line in units of burst transfers each having the DMA burst length=512 bits. On the other hand, when the OSD image data DMA processing section 173 acquires the data of all the pixels of the OSD image for one line in accordance with the OSD cancellation flag, it is possible to acquire data corresponding to the data of all the pixels of the OSD image for one line according to five DMA transfers even when the same unit of 512 bits is used. That is, the DMA cancellation determination section 176 determines whether or not to acquire the OSD image data by pre-acquiring the OSD transparency map and therefore it is possible to reduce the number of DMA transfers when the OSD image data DMA processing section 173 acquires data of all pixels of the OSD image for one line.

In this manner, the display processing section 17 can minimize the number of data transfers when the OSD image data is acquired from the DRAM 30 according to the DMA transfer and reduce an overload on the bus bandwidth of the DRAM bus 11 by reducing the amount of DMA transfers required for acquiring OSD image data, i.e., by cancelling a DMA transfer of unnecessary OSD image data.

Also, when the OSD image data DMA processing section 173 performs three DMA transfers in units of burst transfers each having a DMA burst length=512 bits, a number of pixel data included in the OSD image acquired from the DRAM 30 is a number of data for 1536 pixels. Among pieces of data for 1536 pixels, as shown in FIG. 10, a part of the OSD image data acquired from the DRAM 30 according to the DMA transfer (a part of the OSD image data acquired according to the DMA transfer T3 in FIG. 10) may also include transparent OSD pixel data. In this case, the OSD image data DMA processing section 173 may discard transparent OSD pixel data included in units of DMA transfers as invalid OSD image data. Also, the OSD image data DMA processing section 173 may output the transparent OSD pixel data included in units of DMA transfers to the data superimposition section 174 as pseudo-pixel data when the transparent OSD pixel data is output as data of all pixels of the OSD image for one line acquired from the DRAM 30.

Also, in the above description, as in the OSD image shown in (c) of FIG. 2, an example in which the OSD information is superimposed in the upper-left and lower-right regions of the display image and displayed on the display device 70 has been described. That is, an example in which a major part region other than the regions indicating the OSD information in the upper-left and lower-right regions in the OSD image data of one frame is a transparent pixel region has been described. However, a major part of the OSD image is not necessarily a transparent pixel region. For example, in an OSD image such as a menu screen for changing the operation mode or settings of the imaging device 1, a major part region of one frame becomes a region for causing the display device 70 to display the OSD information, i.e., a non-transparent region. In this case, the number of DMA transfers required for acquiring data of the non-transparent OSD pixels included in the OSD image data for one line is twelve including two transfers for acquiring the OSD transparency map in the DMA cancellation determination section 176 and ten transfers for acquiring non-transparent OSD pixel data included in the OSD image data for one line in the OSD image data DMA processing section 173. That is, the DMA cancellation determination section 176 pre-acquires the OSD transparency map to determine whether or not to acquire the OSD image data and therefore the number of DMA transfers when the OSD image data DMA processing section 173 acquires data of all pixels of an OSD image for one line may increase.

Thus, the display processing device according to the embodiment of the present invention performs switching between whether to perform the acquisition of the OSD image data on the basis of a result of making a determination of whether to perform the acquisition of the OSD image data, i.e., in accordance with the OSD cancellation flag, and whether to perform the acquisition of the OSD image data without making the determination of whether or not to perform the acquisition of the OSD image data on the basis of a size (a ratio) of a transparent pixel region included in the OSD pixel data. That is, the display processing device according to the embodiment of the present invention performs switching between whether to acquire the OSD image data in a DMA transfer mode in which the OSD image data of the transparent pixel region is not acquired (hereinafter referred to as a “transparency cancellation mode”) and whether to acquire the OSD image data in a DMA transfer mode in which all OSD image data is acquired (hereinafter referred to as a “normal mode”). In the display processing device according to the embodiment of the present invention, the determination for switching the DMA transfer mode for acquiring the OSD image data is made when the OSD data generation section 16 generates the OSD image data and the OSD transparency map.

Here, an operation in which the OSD data generation section 16 switches the DMA transfer mode will be described. Also, in the following description, an example in which the display device 70 displays an image of a VGA size (640 pixels, 480 lines) and a unit of a DMA transfer when each of the OSD image data DMA processing section 173 and the DMA cancellation determination section 176 provided in the display processing section 17 acquires corresponding data from the DRAM 30 according to the DMA transfer is a unit of a burst transfer having a DMA burst length=512 bits will be described. Also, in the following description, an example in which the data of each pixel included in the OSD image data generated by the OSD data generation section 16 is 8 bits, i.e., the number of DMA transfers required to acquire OSD image data in the OSD image data DMA processing section 173 is ten, will be described. Also, in the following description, an example in which the number of bits of the OSD transparency map for one line corresponding to OSD image data for one line generated by the OSD data generation section 16 is 640, i.e., the number of DMA transfers required to acquire data of the OSD transparency map in the DMA cancellation determination section 176 is 2, will be described.

FIG. 11 is a flowchart showing a schematic operation for switching a method of acquiring OSD image data for displaying the OSD image in the display processing device according to the embodiment of the present invention.

When the display processing device according to the embodiment of the present invention starts its operation, the OSD data generation section 16 first acquires settings of a size of an image displayed by the display device 70, a unit of a DMA transfer in each of the OSD image data DMA processing section 173 and the DMA cancellation determination section 176 provided in the display processing section 17, and the number of bits of the generated OSD image data and the data of the generated OSD transparency map. Then, the OSD data generation section 16 calculates the transparency ratio threshold value Rth for determining the switching of the DMA transfer mode on the basis of the settings of the size of the image displayed by the display device 70, the unit of the DMA transfer in each of the OSD image data DMA processing section 173 and the DMA cancellation determination section 176 provided in the display processing section 17, and the number of bits of the generated OSD image data and the data of the generated OSD transparency map. Then, the OSD data generation section 16 sets the calculated transparency ratio threshold value Rth (step S100).

More specifically, the OSD data generation section 16 calculates the number of DMA transfers required for the DMA transfer of the OSD image data as 10 because the acquired number of pixels for one line of an image to be displayed by the display device 70 is 640, the unit of the DMA transfer in the OSD image data DMA processing section 173 is 512 bits (the DMA burst length), and the number of bits of the generated OSD image data is 8 (see the above Equations (1) and (2)). Also, likewise, the OSD data generation section 16 calculates the number of DMA transfers required for the DMA transfer of the OSD transparency map as 2 because the acquired number of pixels for one line of an image to be displayed by the display device 70 is 640, the setting of the DMA transfer in the DMA cancellation determination section 176 is 512 bits (the DMA burst length), and the number of bits of the data of the generated OSD transparency map is 1. Then, the OSD data generation section 16 calculates a transparency ratio threshold value Rth which is a ratio of the calculated number of DMA transfers required for the DMA transfer of the OSD transparency map (the number of OSD transparency map transfers) to the number of DMA transfers required for the DMA transfer of the OSD image data (the number of OSD image data transfers) according to the following Equation (3).

Transparency ratio threshold value Rth=(Number of OSD transparency map transfers)/(Number of OSD image data transfers)×100=2 (times)/10 (times)×100=20(%) (3)

The OSD data generation section 16 sets the transparency ratio threshold value Rth calculated according to the above Equation (3).

Subsequently, the OSD data generation section 16 starts the generation of the OSD image data and the OSD transparency map. Then, the OSD data generation section 16 calculates an OSD transparency ratio R indicating the size of the transparent pixel region included in the generated OSD image data on the basis of the data of the generated OSD transparency map (step S200).

More specifically, the OSD data generation section 16 counts the number of transparent bit included in the data of the generated OSD transparency map. Then, the OSD data generation section 16 calculates the OSD transparency ratio R which is a ratio of the counted number of transparent bit to the number of bits of the OSD transparency map according to the following Equation (4).

OSD transparency ratio R=(Number of transparent bit)/(Number of bits of OSD transparency map)×100(%) (4)

Subsequently, the OSD data generation section 16 determines whether or not the calculated OSD transparency ratio R is greater than or equal to the set transparency ratio threshold value Rth (step S300).

If a result of the determination in step S300 indicates that the OSD transparency ratio R is greater than or equal to the transparency ratio threshold value Rth (“OSD transparency ratio R≥transparency ratio threshold value Rth”) (“YES” in step S300), the OSD data generation section 16 selects the transparency cancellation mode as the DMA transfer mode of the OSD image data (step S400).

On the other hand, if a result of the determination in step S300 indicates that the OSD transparency ratio R is less than the transparency ratio threshold value Rth (OSD transparency ratio R<transparency ratio threshold value Rth) (“NO” in step S300), the OSD data generation section 16 selects the normal mode as the DMA transfer mode of the OSD image data (step S500).

According to such a process, the OSD data generation section 16 selects the DMA transfer mode when the display processing section 17 (more specifically, the OSD image data DMA processing section 173 provided in the display processing section 17) acquires the OSD image data from the DRAM 30 according to the DMA transfer. Here, information of the DMA transfer mode of the OSD image data selected by the OSD data generation section 16 is output to the display processing section 17 (more specifically, the DMA cancellation determination section 176 provided in the display processing section 17). Thereby, the DMA cancellation determination section 176 changes the OSD cancellation flag to be output to the OSD image data DMA processing section 173 in accordance with the information of the DMA transfer mode output from the OSD data generation section 16. More specifically, if the information indicating that the transparency cancellation mode is selected as the DMA transfer mode of the OSD image data is input from the OSD data generation section 16, the DMA cancellation determination section 176 acquires the data of the OSD transparency map from the DRAM 30 according to the DMA transfer and outputs the OSD cancellation flag indicating that the acquisition of OSD image data is performed or that the acquisition of OSD image data is not performed (cancelled) as shown in FIG. 9 to the OSD image data DMA processing section 173. On the other hand, if the information indicating that the normal mode is selected as the DMA transfer mode of the OSD image data is input from the OSD data generation section 16, the DMA cancellation determination section 176 outputs the OSD cancellation flag (for example, the “Low” level) indicating that the acquisition of the OSD image data is performed to the OSD image data DMA processing section 173 without acquiring the data of the OSD transparency map from the DRAM 30 according to the DMA transfer. Thereby, the OSD image data DMA processing section 173 can acquire the OSD image data for one frame stored (written) in the DRAM 30 according to an appropriate DMA transfer on the basis of the size (a ratio) of a transparent pixel region included in the OSD image data.

Also, the OSD data generation section 16 may calculate the OSD transparency ratio R according to the above Equation (4) in step S200 for each line of the OSD transparency map, i.e., each line of the OSD image data, or for the entire OSD transparency map, i.e., OSD image data of one frame. At this time, an OSD transparency ratio R having a largest value among OSD transparency ratios R calculated for each lines of the OSD image data may be the OSD transparency ratio R in the OSD image data of one frame.

Also, if the OSD data generation section 16 has calculated the OSD transparency ratio R for each line of the OSD transparency map, the determination in step S300 is made for each line of the OSD image data. In this case, the DMA cancellation determination section 176 can switch the DMA transfer mode for acquiring the OSD image data for each line of the OSD image data and the OSD image data DMA processing section 173 can acquire the OSD image data according to an appropriate DMA transfer for each line of the OSD image data. On the other hand, if the OSD data generation section 16 has calculated the OSD transparency ratio R for the entire OSD transparency map, the determination in step S300 is made for OSD image data of one frame. In this case, the DMA cancellation determination section 176 can switch the DMA transfer mode for acquiring the OSD image data in units of OSD image data of one frame, and the OSD image data DMA processing section 173 can acquire OSD image data by performing the DMA transfer at a similar timing for each line of the OSD image data.

According to such a configuration and operation, in the display processing device according to the embodiment of the present invention, the amount of unnecessary OSD image data transfers can be minimized and an overload on the bus bandwidth of the DRAM bus 11 can be reduced when OSD image data is acquired from the DRAM 30 according to the DMA transfer.

According to the present embodiment, a display processing device for superimposing a superimposed image (an OSD image) for displaying additional information on a display image on the basis of transparency information indicating transparency when each pixel included in the OSD image is displayed and causing the OSD image superimposed on the display image to be displayed, the display processing device comprising a superimposed image generation section (the OSD data generation section 16), and a display processing section (the display processing section 17), wherein the OSD data generation section 16 is configured to generate the OSD image including the transparency information, generate a transparency map (an OSD transparency map) indicating whether each pixel included in the OSD image is a transparent pixel (a transparent OSD pixel) or a non-transparent pixel (a non-transparent OSD pixel) on the basis of the transparency information, and cause a storage section (the DRAM 30) connected to a common bus (the DRAM bus 11) to store the OSD image and the OSD transparency map, the OSD image and the OSD transparency map being associated with each other, the display processing section 17 is configured to superimpose a pseudo-pixel representing that a pixel is a transparent pixel in a pseudo manner when the transparent OSD pixel included in the OSD image which has not been acquired from the DRAM 30 in predetermined units of transfers (units of DMA transfers) is superimnposed on the display image on the basis of the OSD transparency map which has been pre-acquired from the DRAM 30.

Also, according to the present embodiment, the display processing device in which the OSD data generation section 16 is configured to generate the OSD transparency map having a smaller amount of data than the OSD image, the display processing section 17 includes a superimposed image acquisition determination section (the DMA cancellation determination section 176), a superimposed image acquisition section (the OSD image data DMA processing section 173), and an image superimposition section (the data superimposition section 174), the DMA cancellation determination section 176 is configured to determine whether or not to acquire the transparent OSD pixel included in the acquired OSD image in the units of DMA transfers on the basis of the OSD transparency map corresponding to the acquired OSD image before the OSD image is acquired from the DRAM 30, and to output a flag signal (an OSD cancellation flag) indicating a determination result; the OSD image data DMA processing section 173 is configured not to acquire the transparent OSD pixel indicated not to be acquired by the OSD cancellation flag in the units of DMA transfers when the OSD image is acquired from the DRAM 30 in the units of DMA transfers, and to output an image for superimposition (OSD image data) including the pseudo-pixel instead of the transparent OSD pixel which has not acquired; and the data superimposition section 174 is configured to superimpose the image for superimposition (the OSD image according to the OSD image data output by the OSD image data DMA processing section 173) on the display image and generate an image signal for causing the image for superimposition superimposed on the display image to be displayed on the display device is configured.

Also, according to the present embodiment, the display processing device in which the OSD data generation section 16 is configured to calculate a transparency ratio (an OSD transparency ratio R) which is a ratio of transparent OSD pixels to pixels included in the OSD image, the DMA cancellation determination section 176 is configured to acquire the OSD transparency map from the DRAM 30 if the OSD transparency ratio R is greater than or equal to a predetermined threshold value (a transparency ratio threshold value Rth) and outputs the OSD cancellation flag indicating the determination result on the basis of the acquired OSD transparency map, and the DMA cancellation determination section 176 is configured not to acquire the OSD transparency map from the DRAM 30 if the transparency ratio is less than the threshold value, and to output the OSD cancellation flag indicating that all pixels included in the acquired OSD image are acquired in units of DMA transfers is configured.

Also, according to the present embodiment, the display processing device in which the OSD data generation section 16 is configured to generate an OSD image and an OSD transparency map during a period in which the OSD image data DMA processing section 173 does not acquire an OSD image is configured.

Also, according to the present embodiment, the display processing device in which the display processing section 17 further includes a synchronous signal generation section (the synchronous signal generation section 171) configured to generate a synchronous signal (a vertical synchronous signal VD, a horizontal synchronous signal HD, or the like), the synchronous signal being the timing signal for causing the display device (the display device 70) to display the image signal, and a period in which the OSD image data DMA processing section 173 does not acquire the OSD image is a blanking period (a vertical blanking period) indicated by the vertical synchronous signal VD is configured.

Also, according to the present embodiment, the display processing device in which the OSD data generation section 16 starts the generation of the OSD image and the OSD transparency map from a timing of a start of the vertical blanking period is configured.

Also, according to the present embodiment, the display processing device in which the OSD data generation section 16 starts the generation of the OSD image and the OSD transparency map from a timing at which a predetermined period (a period in which it is determined that the DMA transfer of another component has been completed) has elapsed from a start of the vertical blanking period is configured.

Also, according to the present embodiment, the display processing device in which the OSD data generation section 16 is configured to generate the OSD image and the OSD transparency map during a division period in which the amount of data transfers in the DRAM bus 11 measured for each division period obtained by dividing a period (a period of one frame) in which a bus bandwidth monitor (the DRAM bus arbitration section 13) connected to the DRAM bus 11 causes the display device 70 to display the image signal into predetermined equal intervals is small is configured.

Also, according to the present embodiment, there is provided an image device (the imaging device 1) including a display processing device (a display processing device of the present invention) for superimposing a superimposed image (an OSD image) for displaying additional information on a display image on the basis of transparency information indicating transparency when each pixel included in the OSD image is displayed and causing the OSD image superimposed on the display image to be displayed, the display processing device comprising a superimposed image generation section (the OSD data generation section 16), and a display processing section (the display processing section 17), wherein the OSD data generation section 16 is configured to generate the OSD image including the transparency information, generate a transparency map (an OSD transparency map) indicating whether each pixel included in the OSD image is a transparent pixel (a transparent OSD pixel) or a non-transparent pixel (a non-transparent OSD pixel) on the basis of the transparency information and cause a storage section (the DRAM 30) connected to a common bus (the DRAM bus 11) to store the OSD image and the OSD transparency map, the OSD image and the OSD transparency map being associated with each other, the display processing section 17 is configured to superimpose a pseudo-pixel representing that a pixel is a transparent pixel in a pseudo manner when the transparent OSD pixel included in the OSD image which has not been acquired from the DRAM 30 in predetermined units of transfers (units of DMA transfers) is superimposed on the display image on the basis of the OSD transparency map which has been pre-acquired from the DRAM 30.

As described above, according to the embodiment of the present invention, the on-screen display data generation section constituting the display processing device of the present invention is configured to generate an on-screen display image to be displayed on the display device and is configured to generate an on-screen display transparency map (an OSD transparency map in the embodiment) which indicates whether or not each pixel included in the on-screen display image is transparent and has a smaller amount of data than the on-screen display image. In the embodiment of the present invention, the display processing section constituting the display processing device of the present invention determines whether or not to acquire (read) data of the on-screen display image from the storage device according to the DMA transfer on the basis of the on-screen display transparency map generated by the on-screen display data generation section. In other words, in the embodiment of the present invention, the display processing section constituting the display processing device of the present invention determines whether or not to perform the DMA transfer when data of the on-screen display image is acquired (read) from the storage device on the basis of the on-screen display transparency map generated by the on-screen display data generation section. Thereby, in the embodiment of the present invention, it is possible to prevent transparent pixel data within the on-screen display image located in a region where the transparent pixel data is not displayed (not reflected) as the on-screen display information even when the transparent pixel data is superimposed on the display image to be displayed on the display device from being acquired according to the DMA transfer, i.e., prevent unnecessary data of the on-screen display image from being transmitted. Thereby, in the embodiment of the present invention, the display processing section constituting the display processing device of the present invention can minimize the amount of data transfers when data of the on-screen display image is acquired (read) from the storage device according to the DMA transfer and can reduce an overload on the bus bandwidth of the data bus connected to and shared by a plurality of processing devices including the display processing device of the present invention.

Also, in the embodiment of the present invention, a case in which the OSD transparency map generated by the OSD data generation section 16 has a type of bitmap data indicating whether or not each pixel included in the OSD image is transparent by 1-bit data has been described. However, a type of OSD transparency map is not limited to a type in which whether or not each pixel included in the OSD image is transparent is indicated by 1-bit data.

For example, 1-bit data (a value) included in the OSD transparency map may be of a type indicating whether or not a pixel is transparent for each unit of a DMA transfer when the display processing section 17 acquires OSD image data from the DRAM 30. In this case, in the OSD transparency map, a pixel is indicated by a value indicating a transparent OSD pixel (for example, “0”) if all pixels in the OSD image data included in the unit of the DMA transfer acquired by the display processing section 17 are transparent pixels and a pixel is indicated by a value indicating a non-transparent OSD pixel (for example, “1”) if any pixel in the OSD image data included in the unit of the DMA transfer acquired by the display processing section 17 is a pixel which is non-transparent (a non-transparent pixel). In such a type of OSD transparency map, it is possible to reduce the amount of data compared with an OSD transparency map of a type in which the pixel is indicated by 1-bit data for each pixel included in the OSD image described in the embodiment. More specifically, as described in the embodiment, the number of bits of the OSD transparency map for one line corresponding to the OSD image data for one line for causing the display device 70 for displaying an image of the VGA size (640 pixels×480 lines) to display an OSD image is 640. On the other hand, as described in the embodiment, because the OSD transparency map corresponding to the OSD image data for one line can represent the OSD transparency map for 64 pixels by one bit when the unit of the DMA transfer is 512 bits (a DMA burst length), the number of bits of the OSD transparency map for one line is 10 which is the same as the number of DMA transfers. Also, in such a type of OSD transparency map, data (a value) of each bit included in the OSD transparency map may be obtained by combining data for a plurality of units of DMA transfers in which the display processing section 17 acquires OSD image data from the DRAM 30 (for example, for two units of DMA transfers).

Also, for example, information indicating whether or not each pixel in the OSD image data included in the OSD transparency map is transparent may be of a type in which the information is indicated by the number of consecutive pixels which are the same, i.e., a type of so-called run-length compression. In this case, the data included in the OSD transparency map becomes data of a combination of data for identifying a transparent OSD pixel or a non-transparent OSD pixel and the number of consecutive pixels (the combination may be iterated a plurality of times). In such a type of OSD transparency map, it is possible to reduce an amount of data compared with a type of OSD transparency map in which the pixel is indicated by 1-bit data for each pixel included in the OSD image described in the embodiment. However, in the case of such a type of OSD transparency map, for example, when a transparent OSD pixel and a non-transparent OSD pixel are alternately iterated, the amount of data may be increased. However, if an increased amount of data (the increased number of bits) of the OSD transparency map is less than or equal to the number of unused bit which are not used when it is determined whether or not to perform the acquisition of the OSD image data (see FIG. 10), it is possible to allow an increase in the amount of data. In other words, even when the amount of data (the number of bits) of the OSD transparency map has increased, it is possible to allow an increase in the amount of data of the OSD transparency map if the amount of data (the number of bits) is the number of bits within a unit in which the OSD transparency map is transferred according to the DMA transfer, i.e., if the number of DMA transfers when the OSD transparency map is acquired does not increase. For example, if information indicated by the OSD transparency map is a combination of data for identifying whether or not a pixel is transparent for every DMA transfer unit (for example, every 64-pixel unit) when the display processing section 17 acquires OSD image data and a number of consecutive data, the number of bits of the OSD transparency map for one line is 20 even when data indicating that a pixel is transparent for every DMA transfer unit and data indicating that a pixel is non-transparent are iterated. In this case, it is possible to allow an increase in the amount of data of the OSD transparency map.

Also, in the embodiment of the present invention, a case in which an OSD image according to OSD image data for one frame generated by the OSD data generation section 16 is superimposed on the display image according to the display image data has been described. However, the number of OSD images (the number of frames) according to the OSD image data superimposed on the display image according to the display image data is not limited to the number of frames (one frame) described in the embodiment of the present invention. That is, an OSD image according to OSD image data for a plurality of frames (for example, two frames) may be superimposed on a display image according to display image data. A concept of such a case is similar to a concept shown in the embodiment of the present invention. Accordingly, detailed description of a case in which an OSD image according to OSD image data for a plurality of frames is superimposed on a display image according to display image data is omitted.

While preferred embodiments of the present invention have been described and shown above, the present invention is not limited to the embodiments and modified examples thereof. Within a range not departing from the gist or spirit of the present invention, additions, omissions, substitutions, and other modifications to the configuration can be made.

Also, the present invention is not to be considered as being limited by the foregoing description, and is limited only by the scope of the appended claims.

What is claimed is:

1. A display processing device for superimposing a superimposed image for displaying additional information on a display image on the basis of transparency information indicating transparency when each pixel included in the superimposed image is displayed and causing the superimposed image superimposed on the display image to be displayed,
the display processing device comprising
a superimposed image generation section, and
a display processing section,
wherein the superimposed image generation section is configured to generate the superimposed image including the transparency information, generate a transparency map indicating whether each pixel included in the superimposed image is a transparent pixel or a non-transparent pixel on the basis of the transparency information, and cause a storage section connected to a common bus to store the superimposed image and the transparency map, the superimposed image and the transparency map being associated with each other,
the display processing section is configured to superimpose a pseudo-pixel representing that a pixel is a transparent pixel in a pseudo manner when the transparent pixel included in the superimposed image which has not been acquired from the storage section in predetermined units of transfers is superimposed on the display image on the basis of the transparency map which has been pre-acquired from the storage section,
wherein the superimposed image generation section is configured to generate the transparency map having a smaller amount of data than the superimposed image,
wherein the display processing section includes a superimposed image acquisition determination section, a superimposed image acquisition section, and an image superimposition section,
the superimposed image acquisition determination section is configured to determine whether or not to acquire the transparent pixel included in the acquired superimposed image in the units of transfers on the basis of the transparency map corresponding to the acquired superimposed image before the superimposed image is acquired from the storage section, and to output a flag signal indicating a determination result;
the superimposed image acquisition section is configured not to acquire the transparent pixel indicated not to be acquired by the flag signal in the units of transfers when the superimposed image is acquired from the storage section in the units of transfers, and to output an image for superimposition including the pseudo-pixel instead of the transparent pixel which has not acquired; and
the image superimposition section is configured to superimpose the image for superimposition on the display image and generate an image signal for causing the image for superimposition superimposed on the display image to be displayed on the display device,
wherein the superimposed image generation section is configured to calculate a transparency ratio which is a ratio of transparent pixels to pixels included in the superimposed image,
wherein the superimposed image acquisition determination section is configured to acquire the transparency map from the storage section if the transparency ratio is greater than or equal to a predetermined threshold value and outputs the flag signal indicating the determination result on the basis of the acquired transparency map, and
wherein the superimposed image acquisition determination section is configured not to acquire the transparency map from the storage section if the transparency ratio is less than the threshold value, and to output the flag signal indicating that all pixels included in the acquired superimposed image are acquired in the units of transfers.

2. The display processing device according to claim 1,
wherein the superimposed image generation section is configured to generate the superimposed image and the transparency map during a period in which the superimposed image acquisition section does not acquire the superimposed image.

3. The display processing device according to claim 2,
wherein the display processing section further includes a synchronous signal generation section configured to generate a synchronous signal, the synchronous signal being the timing signal for causing the display device to display the image signal, and
wherein a period in which the superimposed image acquisition section does not acquire the superimposed image is a blanking period indicated by the synchronous signal.

4. The display processing device according to claim 3,
wherein the superimposed image generation section starts the generation of the superimposed image and the transparency map from a timing of a start of the blanking period.

5. The display processing device according to claim 3,
wherein the superimposed image generation section starts the generation of the superimposed image and the transparency map from a timing at which a predetermined period has elapsed from a start of the blanking period.

6. The display processing device according to claim 1,
wherein the superimposed image generation section is configured to generate the superimposed image and the transparency map during a division period in which the amount of data transfers in the common bus measured for each division period obtained by dividing a period in which a bus bandwidth monitor connected to the common bus causes the display device to display the image signal into predetermined equal intervals is small.

7. An imaging device including a display processing device for superimposing a superimposed image for displaying additional information on a display image on the basis of transparency information indicating transparency when each pixel included in the superimposed image is displayed and causing the superimposed image superimposed on the display image to be displayed,
the display processing device comprising
a superimposed image generation section, and
a display processing section,
wherein the superimposed image generation section is configured to generate the superimposed image including the transparency information, generate a transparency map indicating whether each pixel included in the superimposed image is a transparent pixel or a non-transparent pixel on the basis of the transparency information, and cause a storage section connected to a common bus to store the superimposed image and the transparency map, the superimposed image and the transparency map being associated with each other,
the display processing section is configured to superimpose a pseudo-pixel representing that a pixel is a transparent pixel in a pseudo manner when the transparent pixel included in the superimposed image which has not been acquired from the storage section in predetermined units of transfers is superimposed on the display image on the basis of the transparency map which has been pre-acquired from the storage section,
wherein the superimposed image generation section is configured to generate the transparency map having a smaller amount of data than the superimposed image,
wherein the display processing section includes a superimposed image acquisition determination section, a superimposed image acquisition section, and an image superimposition section,
the superimposed image acquisition determination section is configured to determine whether or not to acquire the transparent pixel included in the acquired superimposed image in the units of transfers on the basis of the transparency map corresponding to the acquired superimposed image before the superimposed image is acquired from the storage section, and to output a flag signal indicating a determination result;
the superimposed image acquisition section is configured not to acquire the transparent pixel indicated not to be acquired by the flag signal in the units of transfers when the superimposed image is acquired from the storage section in the units of transfers, and to output an image for superimposition including the pseudo-pixel instead of the transparent pixel which has not acquired; and
the image superimposition section is configured to superimpose the image for superimposition on the display image and generate an image signal for causing the image for superimposition superimposed on the display image to be displayed on the display device,
wherein the superimposed image generation section is configured to calculate a transparency ratio which is a ratio of transparent pixels to pixels included in the superimposed image,
wherein the superimposed image acquisition determination section is configured to acquire the transparency map from the storage section if the transparency ratio is greater than or equal to a predetermined threshold value and outputs the flag signal indicating the determination result on the basis of the acquired transparency map, and
wherein the superimposed image acquisition determination section is configured not to acquire the transparency map from the storage section if the transparency ratio is less than the threshold value, and to output the flag signal indicating that all pixels included in the acquired superimposed image are acquired in the units of transfers.
